(19) United States
(12) Patent Application Publication
(10) Pub. No.: US 2026/0052324 A1
(43) Pub. Date: Feb. 19, 2026

(54) LIGHT DETECTION ELEMENT AND ELECTRONIC DEVICE

(71) Applicant: SONY SEMICONDUCTOR SOLUTIONS CORPORATION, KANAGAWA (JP)

(72) Inventors: Toru TAKAYAMA, KANAGAWA (JP); Kengo UMEDA, KANAGAWA (JP); Haruhisa NAGANOKAWA, KANAGAWA (JP)

(21) Appl. No.: 19/104,276

(22) PCT Filed: Jul. 11, 2023
(86) PCT No.: PCT/JP2023/025605

§ 371 Date: Feb. 17, 2025

(30) Foreign Application Priority Data
Aug. 25, 2022 (JP) 2022-134406

(51) Int. Cl. H04N 25/771; H04N 25/766; H04N 25/767; H04N 25/78

(52) U.S. Cl. CPC H04N 25/771; H04N 25/766; H04N 25/767; H04N 25/78

(57) ABSTRACT

To provide a light detection element capable of minimizing performance deterioration in signal processing while avoiding an increase in size of a circuit used for digital conversion processing of an analog pixel signal.

A light detection element of the present disclosure includes a plurality of pixels arranged in a matrix. The plurality of pixels includes: a photoelectric conversion circuit that photoelectrically converts incident light to output an analog pixel signal; a comparator that outputs a result of comparing the analog pixel signal with a reference signal; a storage circuit that stores data of an output signal of the comparator; and a switching circuit that switches an output destination of the analog pixel signal or the output signal to share the storage circuit among the plurality of pixels.

### TECHNICAL FIELD

The present disclosure relates to a light detection element and an electronic device.

### BACKGROUND ART

A light detection element used in a CMOS image sensor or the like is provided with an AD converter that digitally converts an analog pixel signal. In the AD converter, a comparator compares an analog pixel generated by photoelectric conversion by a photodiode with a ramp signal. Furthermore, a latch circuit (storage circuit) stores a result of comparison by the comparator.

The number of latch circuits is determined according to an operation mode of the light detection element. For example, in image-plane phase difference AF processing, three latch circuits are required per pixel. When the number of latch circuits increases, a circuit of the AD converter increases in size, and thus one AD converter may not fit within an area of one pixel. In such a case, a measure is taken for sharing one AD converter by a plurality of pixels.

However, since the plurality of pixels sharing the latch circuit is driven by a rolling shutter system, a global shutter cannot be used. Thus, there is a concern about adverse effects of performance deterioration such as occurrence of focal plane distortion and deterioration in signal processing speed.

### CITATION LIST

### Patent Document

Patent Document 1: WO 2016/009832 A

### SUMMARY OF THE INVENTION

### Problems to be Solved by the Invention

The present disclosure provides a light detection element and an electronic device capable of minimizing performance deterioration in signal processing while avoiding an increase in size of a circuit used for digital conversion processing of an analog pixel signal.

### Solutions to Problems

A light detection element of the present disclosure includes a plurality of pixels arranged in a matrix. The plurality of pixels includes: a photoelectric conversion circuit that photoelectrically converts incident light to output an analog pixel signal; a comparator that outputs a result of comparing the analog pixel signal with a reference signal; a storage circuit that stores data of an output signal of the comparator; and a switching circuit that switches an output destination of the analog pixel signal or the output signal to share the storage circuit among the plurality of pixels.

The switching circuit may be connected to an output terminal of the comparator.

The switching circuit may be arranged on an input terminal side of the comparator.

The photoelectric conversion circuit may include a first photodiode and a second photodiode connected to an input terminal of the comparator,
the comparator may output a first output signal when the photoelectric conversion circuit is in a reset state, output a second output signal indicating a result of comparison between an analog pixel signal when the first photodiode photoelectrically converts the incident light and the reference signal, and output a third output signal indicating a result of comparison between an analog pixel signal when the first photodiode and the second photodiode photoelectrically convert the incident light and the reference signal,
the storage circuit may include a plurality of latch circuits, and
the switching circuit may switch output destinations of the first output signal, the second output signal, and the third output signal to different latch circuits, respectively.

The photoelectric conversion circuit may include a first photodiode connected to an input terminal of the comparator,
the comparator may output a first output signal when the photoelectric conversion circuit is in a reset state, and output a plurality of times a second output signal indicating a result of comparison between an analog pixel signal when the first photodiode photoelectrically converts the incident light and the reference signal,
the storage circuit may include a plurality of latch circuits, and
the switching circuit may switch output destinations of the first output signal and the second output signal of each time to different latch circuits, respectively.

The comparator may output the second output signal a plurality of times by performing AD conversion processing on an analog pixel signal once transferred to a floating diffusion layer a plurality of times.

The comparator may output the second output signal under different conditions every time.

The comparator may output the second output signal under a condition that a gain of at least one of the analog pixel signal or the reference signal is changed.

The switching circuit may switch an output destination of the analog pixel signal or the output signal to cause pixels adjacent to each other to share the storage circuit, among the plurality of pixels.

The plurality of pixels may individually receive beams of light of a plurality of colors, and
the storage circuit may be shared by pixels that receive light of an identical color.

The plurality of pixels may include a first pixel and a second pixel adjacent to the first pixel,
the storage circuit may include a first latch circuit and a second latch circuit, and
the switching circuit may select, as an output destination of the first output signal, the first latch circuit of the first pixel, select, as an output destination of the second output signal, the second latch circuit of the first pixel, and select, as an output destination of the third output signal, the first latch circuit of the second pixel.

The plurality of pixels may include a first pixel and a second pixel adjacent to the first pixel,
the comparator may output the second output signal twice,
the storage circuit may include a first latch circuit and a second latch circuit, and
the switching circuit may select, as an output destination of the first output signal, the first latch circuit of the first pixel, select, as an output destination of the second output signal of a first time, the second latch circuit of the first pixel, and select, as an output destination of the second output signal of a second time, the first latch circuit of the second pixel.

The plurality of pixels may include a first pixel to a fourth pixel arranged close to each other,
the storage circuit may include a first latch circuit, and
the number of pixels sharing the first latch circuit may be variable among the first pixel to the fourth pixel.

There may be further included:
a first chip in which a plurality of photoelectric conversion circuits is arranged; and
a second chip in which a plurality of comparators, a plurality of storage circuits, a plurality of switching circuits, and a repeater that reads the data from the storage circuits are arranged, and
the repeater may be arranged at a position facing the center of the plurality of photoelectric conversion circuits, and the plurality of comparators, the plurality of storage circuits, and the plurality of switching circuits may be arranged symmetrically with the repeater interposed therebetween.

The storage circuits may be arranged on both sides of the repeater, the comparators may be arranged on one sides of the storage circuits, and the switching circuits may be arranged on one sides of the comparators.

The switching circuit may include a multiplexer.

The switching circuit may include:
a first switching element that switches whether or not to output the analog pixel signal to a first pixel among the plurality of pixels; and
a second switching element that switches whether or not to output the analog pixel signal to a second pixel different from the first pixel.

The photoelectric conversion circuit may include a selection transistor that switches whether or not to output the analog pixel signal to a comparator of a first pixel among the plurality of pixels, and
the switching circuit may include a first switching element that switches whether or not to output the analog pixel signal to a comparator of a second pixel different from the first pixel.

The photoelectric conversion circuit may include a transfer transistor that switches whether or not to transfer a charge obtained by photoelectrically converting the incident light to a floating diffusion layer of a first pixel among the plurality of pixels, and
the switching circuit may include a first switching element that switches whether or not to transfer the charge to a floating diffusion layer of a second pixel different from the first pixel.

An electronic device of the present disclosure includes a plurality of pixels arranged in a matrix. The plurality of pixels includes: a photoelectric conversion circuit that photoelectrically converts incident light to output an analog pixel signal; a comparator that outputs a result of comparing the analog pixel signal with a reference signal; a storage circuit that stores data of an output signal of the comparator; and a switching circuit that switches an output destination of the analog pixel signal or the output signal to share the storage circuit among the plurality of pixels.

### BRIEF DESCRIPTION OF DRAWINGS

FIG. 1 is a block diagram illustrating a configuration of a light detection element according to a first embodiment.

FIG. 2 is a block diagram illustrating an example of a circuit configuration of a pixel according to the first embodiment.

FIG. 3 is a block diagram illustrating an example of a circuit configuration of a selection circuit.

FIG. 4 is a diagram illustrating an example of a stacked structure of a light detection element 1 according to the first embodiment.

FIG. 5 is a diagram illustrating a layout example of pixels according to the first embodiment.

FIG. 6 is a diagram illustrating another layout example of the pixels according to the first embodiment.

FIG. 7 is a block diagram illustrating a circuit configuration of a pixel according to Comparative Example 1.

FIG. 8 is a block diagram illustrating a circuit configuration of a pixel according to Comparative Example 2.

FIG. 9 is a timing chart for explaining an operation mode of image-plane phase difference AF of the pixel according to the first embodiment.

FIG. 10 is a timing chart for explaining an operation mode in which image-plane phase difference AF processing by the pixel according to the first embodiment is not executed.

FIG. 11 is a block diagram illustrating an example of a circuit configuration of a pixel according to a second embodiment.

FIG. 12 is a timing chart for explaining multiplex AD processing by the pixel according to the second embodiment.

FIG. 13 is a timing chart for explaining an operation mode in which the multiplex AD processing by the pixel according to the second embodiment is not executed.

FIG. 14 is a block diagram illustrating a circuit configuration of a pixel according to Comparative Example 3.

FIG. 15 is a timing chart for explaining an operation mode in which the multiplex AD processing by the pixel according to Comparative Example 3 is not executed.

FIG. 16 is a timing chart for explaining a bit extension processing by a pixel according to a fourth embodiment.

FIG. 17 is a block diagram illustrating an example of a circuit configuration of a pixel according to a fifth embodiment.

FIG. 18 is a block diagram illustrating an example of a circuit configuration of a pixel according to a sixth embodiment.

FIG. 19 is a block diagram illustrating an example of a circuit configuration of a pixel according to a seventh embodiment.

FIG. 20 is a block diagram illustrating an example of a circuit configuration of a pixel according to an eighth embodiment.

FIG. 21 is a diagram illustrating a layout example of pixels according to the eighth embodiment.

FIG. 22 is a timing chart for explaining an operation mode when the number of pixels sharing the first latch circuit is set to zero.

FIG. 23 is a timing chart for explaining an operation mode when the number of pixels sharing the first latch circuit is set to two.

FIG. 24 is a timing chart for explaining the operation mode of the image-plane phase difference AF processing when the number of pixels sharing the first latch circuit is set to four.

FIG. 25 is a block diagram illustrating an example of a circuit configuration of a pixel according to a ninth embodiment.

FIG. 26 is a diagram illustrating a layout example of pixels according to the ninth embodiment.

FIG. 27 is a block diagram illustrating an example of a circuit configuration of a pixel according to a tenth embodiment.

FIG. 28 is a block diagram illustrating an example of a circuit configuration of a pixel according to an eleventh embodiment.

FIG. 29 is a block diagram illustrating an example of a circuit configuration of a pixel according to a twelfth embodiment.

FIG. 30 is a diagram illustrating an example of a color pattern of pixels according to a thirteenth embodiment.

FIG. 31 is a diagram illustrating another example of the color pattern of the pixels according to the thirteenth embodiment.

FIG. 32 is a diagram illustrating still another example of the color pattern of the pixels according to the thirteenth embodiment.

FIG. 33 is a block diagram illustrating an example of a circuit configuration of pixels arranged with the color pattern illustrated in FIG. 31.

FIG. 34 is a diagram illustrating a layout example of gate wiring lines of transfer transistors respectively provided in the photoelectric conversion circuits illustrated in FIG. 33.

FIG. 35 is a diagram illustrating a layout example of the gate wiring lines of the transfer transistors when the number photoelectric conversion circuits shared is increased.

FIG. 36 is a block diagram illustrating a schematic configuration of an electronic device according to a fourteenth embodiment.

FIG. 37 is a block diagram illustrating an example of a schematic configuration of a vehicle control system.

FIG. 38 is an explanatory diagram illustrating an example of installation positions of an outside-vehicle information detecting section and an imaging section.

### MODE FOR CARRYING OUT THE INVENTION

### First Embodiment

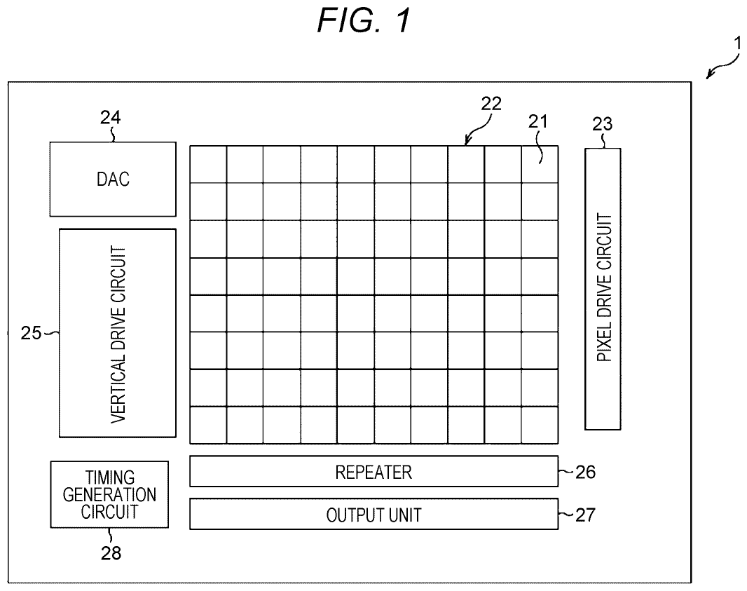

FIG. 1 is a block diagram illustrating a configuration of a light detection element according to a first embodiment. A light detection element 1 illustrated in FIG. 1 includes a pixel array unit 22, a pixel drive circuit 23, a digital to analog converter (DAC) 24, a vertical drive circuit 25, a repeater 26, an output unit 27, and a timing generation circuit 28.

In the pixel array unit 22, a plurality of pixels 21 is arranged in a matrix. A circuit configuration of each pixel 21 will be described later. The pixel drive circuit 23 drives each pixel 21 in the pixel array unit 22. The DAC 24 generates a ramp signal RAMP that is a slope signal whose level (voltage) changes with a lapse of time, and supplies the ramp signal RAMP to each pixel 21. The vertical drive circuit 25 outputs a digital pixel signal generated in the pixel 21 to the repeater 26 in a predetermined order on the basis of a timing signal supplied from the timing generation circuit 28. The repeater 26 reads data of the digital pixel signal from the pixel 21 and transfers the data to the output unit 27. The output unit 27 performs predetermined digital processing such as black level correction processing for correcting a black level or correlated double sampling (CDS) processing. The timing generation circuit 28 includes a timing generator that generates various timing signals and the like, and supplies the generated various timing signals to the pixel drive circuit 23, the DAC 24, the vertical drive circuit 25, and the like.

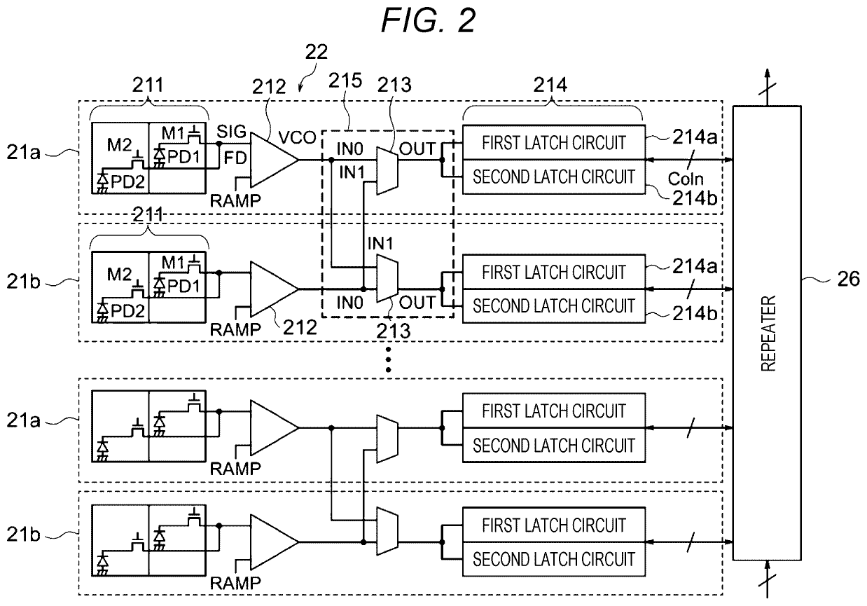

FIG. 2 is a block diagram illustrating an example of a circuit configuration of a pixel according to the first embodiment. A pixel 21a (first pixel) and a pixel 21b (second pixel) illustrated in FIG. 2 each include a photoelectric conversion circuit 211, a comparator 212, a selection circuit 213, and a storage circuit 214. The pixel 21a and the pixel 21b have a relationship of sharing each storage circuit 214, and are arranged adjacent to each other. Furthermore, the comparator 212 and the storage circuit 214 are configured as an analog to digital converter (ADC) that digitally converts an analog pixel signal SIG output from the photoelectric conversion circuit 211. Moreover, the selection circuits 213 of the pixel 21a and the pixel 21b each are configured as a switching circuit 215 that switches an output destination of the analog pixel signal SIG to the storage circuit 214 of the pixel 21a or the storage circuit 214 of the pixel 21b.

The photoelectric conversion circuit 211 includes a first photodiode PD1, a second photodiode PD2, a first transfer transistor M1, and a second transfer transistor M2. In the present embodiment, in order to execute image-plane phase difference auto focus (AF) processing, the pixel 21a and the pixel 21b each are divided by the first photodiode PD1 and the second photodiode PD2.

The first photodiode PD1 and the second photodiode PD2 are examples of photoelectric conversion elements that photoelectrically convert incident light. The anode of the first photodiode PD1 is grounded, and the cathode is connected to a first input terminal of the comparator 212 via the first transfer transistor M1. Meanwhile, the anode of the second photodiode PD2 is also grounded, and the cathode is connected to the first input terminal of the comparator 212 via the second transfer transistor M2.

The first transfer transistor M1 and the second transfer transistor M2 each include, for example, an N-channel MOS transistor. The drain of the first transfer transistor M1 is connected to the cathode of the first photodiode PD1, and the source is connected to the first input terminal of the comparator 212. Meanwhile, the drain of the second transfer transistor M2 is connected to the cathode of the second photodiode PD2, and the source is connected to the first input terminal of the comparator 212.

A transfer signal is input from the pixel drive circuit 23 to the gate of each of the first transfer transistor M1 and the second transfer transistor M2. The first transfer transistor M1 and the second transfer transistor M2 perform switching operation on the basis of the transfer signal. When the first transfer transistor M1 is turned on, charges accumulated by photoelectric conversion of the first photodiode PD1 are transferred to a floating diffusion layer FD. Furthermore, when the second transfer transistor M2 is turned on, charges accumulated by photoelectric conversion of the second photodiode PD2 are transferred to the floating diffusion layer FD. In the floating diffusion layer FD, a voltage signal according to an amount of charges is generated as the analog pixel signal SIG. The analog pixel signal SIG is input to the first input terminal of the comparator 212.

Note that a circuit configuration of the photoelectric conversion circuit 211 is not limited to the configuration illustrated in FIG. 2. The photoelectric conversion circuit 211 may be provided with various pixel transistors such as a reset transistor for resetting a potential of the floating diffusion layer FD.

The comparator 212 compares the analog pixel signal SIG input to the first input terminal with the ramp signal RAMP input as a reference signal to a second input terminal.

Furthermore, the comparator 212 outputs an output signal VCO indicating a result of comparison from an output terminal. At this time, when a voltage of the ramp signal RAMP becomes the same as a voltage of the analog pixel signal SIG, a voltage level of the output signal VCO is inverted.

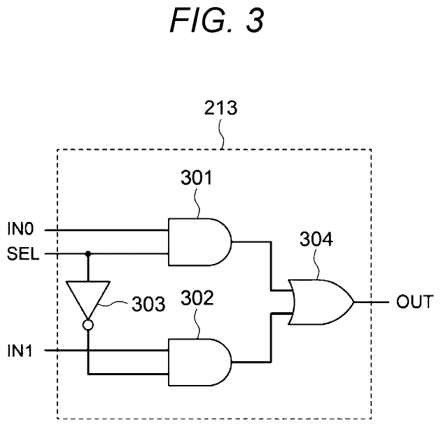

The selection circuit 213 selects an output destination of the output signal VCO in accordance with control by the pixel drive circuit 23. The selection circuit 213 includes, for example, a multiplexer. Here, an example of a circuit configuration of the selection circuit 213 will be described with reference to FIG. 3.

FIG. 3 is a block diagram illustrating the example of the circuit configuration of the selection circuit 213. The selection circuit 213 illustrated in FIG. 3 includes a first AND circuit 301, a second AND circuit 302, an inverter circuit 303, and an OR circuit 304.

The first AND circuit 301 performs a positive logical operation (AND operation) on the output signal VCO input to an input terminal IN0 and a selection signal input to a selection terminal SEL from the pixel drive circuit 23. An operation result by the first AND circuit 301 is input to the OR circuit 304.

The second AND circuit 302 performs a positive logical operation (AND operation) on the output signal VCO input to an input terminal IN1 and the selection signal input to the selection terminal SEL and inverted by the inverter circuit 303. An operation result by the second AND circuit 302 is input to the OR circuit 304.

The OR circuit 304 performs a negative logical operation (OR operation) on the operation result by the first AND circuit 301 and the operation result by the second AND circuit 302. The storage circuit 214 as the output destination of the output signal VCO is selected according to an operation result by the OR circuit 304.

As illustrated in FIG. 2, the storage circuit 214 includes a first latch circuit 214a and a second latch circuit 214b. The first latch circuit 214a and the second latch circuit 214b store digital pixel signals selected by the selection circuit 213, respectively. The first latch circuit 214a and the second latch circuit 214b have the same circuit configuration. A time code that is transmitted from a time code generation unit (not illustrated) and indicates a time at that time is input to each latch circuit. Then, in each latch circuit, an inversion code Coln when the output signal VCO of the comparator 212 is inverted is stored in the first latch circuit 214a and the second latch circuit 214b. In this manner, a digital value obtained by digitizing the analog pixel signal SIG into N (N is a positive number) bits is read by the repeater 26.

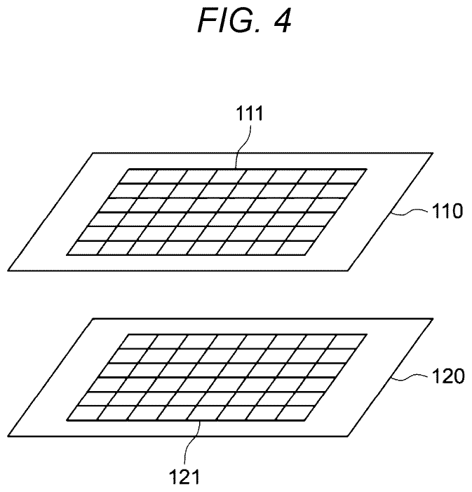

FIG. 4 is a diagram illustrating an example of a stacked structure of the light detection element 1 according to the first embodiment. The light detection element 1 according to the present embodiment includes a sensor chip 110 (first chip) and a logic chip 120 (second chip) stacked on the lower side of the sensor chip 110. The sensor chip 110 and the logic chip 120 are electrically connected together by, for example, so-called Cu—Cu bonding in which copper pads formed on the respective chips are bonded to each other. Note that these chips can be connected together by vias or bumps in addition to Cu—Cu bonding.

The sensor chip 110 includes an upper pixel region 111.

The photoelectric conversion circuit 211 is arranged in the upper pixel region 111. Meanwhile, the logic chip 120 includes a lower pixel region 121. The comparator 212, the selection circuit 213, and the storage circuit 214 are arranged in the lower pixel region 121. Furthermore, although not illustrated in FIG. 4, the pixel drive circuit 23, the DAC 24, the vertical drive circuit 25, the repeater 26, the output unit 27, and the timing generation circuit 28 may be arranged around the lower pixel region 121.

Note that the stacked structure of the sensor chip 110 and the logic chip 120 is not limited to a two-layer structure illustrated in FIG. 3, and may be, for example, a three-layer structure. For example, the comparator 212 is arranged on another chip stacked between the sensor chip 110 and the logic chip 120. In this case, a circuit area can be reduced, and it is possible to support a smaller pixel or to reduce the number of comparators shared can be reduced.

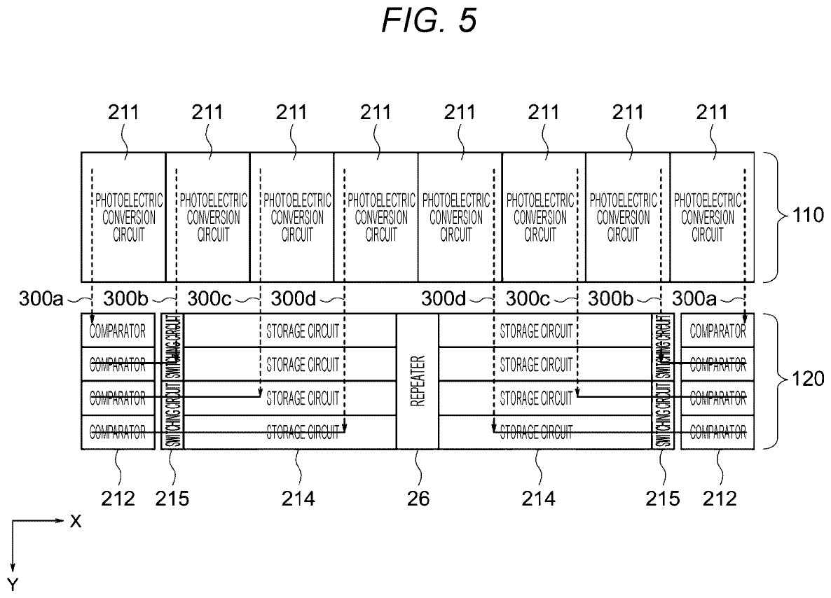

FIG. 5 is a diagram illustrating a layout example of pixels according to the first embodiment. As illustrated in FIG. 5, in the sensor chip 110, eight photoelectric conversion circuits 211 are arranged in a row direction X. In the logic chip 120 stacked with the sensor chip 110, the repeater 26 is arranged at a position facing the center of the eight photoelectric conversion circuits 211. Regarding the repeater 26, one repeater 26 is shared by a pixel group including four sets of pixels 21a and 21b.

The comparators 212, the switching circuits 215, and the storage circuits 214 are arranged symmetrically with the repeater 26 interposed in the row direction X. On each of both sides of the repeater 26 in the row direction X, four storage circuits 214 are arranged in a column direction Y. On one side in the row direction X of a storage circuit group including the four storage circuits 214, two switching circuits 215 are arranged in the column direction Y. On one side in the row direction X of a switching circuit group including the two switching circuits 215, four comparators 212 are arranged in the column direction Y. The four comparators 212 are individually connected to the photoelectric conversion circuits 211 by wiring lines 300a to 300d.

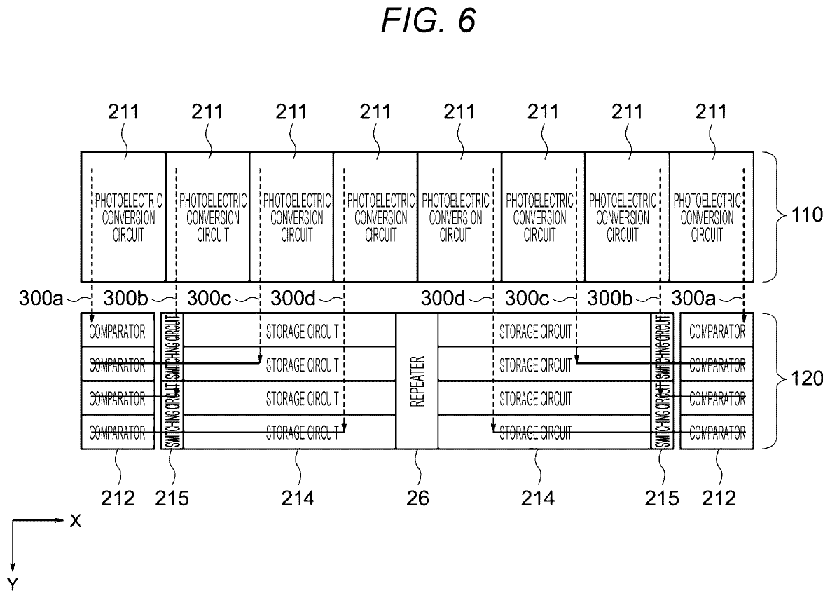

FIG. 6 is a diagram illustrating another layout example of the pixels according to the first embodiment. The layout illustrated in FIG. 6 is different from the layout illustrated in FIG. 5 in the layout of wiring lines 300.

In FIG. 5, the wiring line 300b is formed so as to connect the photoelectric conversion circuit 211 arranged second from the left and the photoelectric conversion circuit 211 arranged second from the right to the comparators 212 arranged second from the top. Furthermore, the wiring line 300c is formed so as to connect the photoelectric conversion circuit 211 arranged third from the left and the photoelectric conversion circuit 211 arranged third from the right to the comparators 212 arranged third from the top.

On the other hand, in FIG. 6, the wiring line 300b is formed so as to connect the photoelectric conversion circuit 211 arranged second from the left and the photoelectric conversion circuit 211 arranged second from the right to the comparators 212 arranged third from the top. Furthermore, the wiring line 300c is formed so as to connect the photoelectric conversion circuit 211 arranged third from the left and the photoelectric conversion circuit 211 arranged third from the right to the comparators 212 arranged second from the top. As described above, the pixels sharing the storage circuit 214 can be easily changed by rearrangement of the wiring lines 300a to 300d.

Here, a description will be given of Comparative Examples 1 and 2 to be compared with the pixel according to the present embodiment described above.

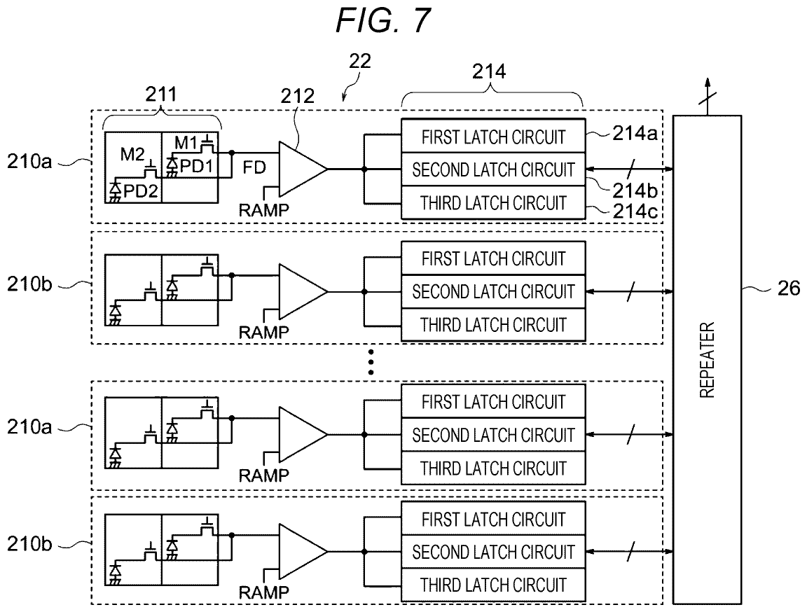

FIG. 7 is a block diagram illustrating a circuit configuration of a pixel according to Comparative Example 1. In FIG. 7, circuit elements similar to those of the pixel 21a and the pixel 21b according to the first embodiment are denoted by the same reference signs, and a detailed description thereof will be omitted.

A pixel 210a and a pixel 210b illustrated in FIG. 7 do not include the selection circuit 213. Meanwhile, the storage circuit 214 of each pixel includes a third latch circuit 214c in addition to the first latch circuit 214a and the second latch circuit 214b. In the pixel 210a and the pixel 210b, three latch circuits are required for one photoelectric conversion circuit 211 in order to execute the image-plane phase difference AF processing. As described above, in the pixel according to the present comparative example, the number of latch circuits is larger than that of the pixel according to the present embodiment. Thus, there is a high possibility that a space for forming the storage circuit 214 cannot be secured in the lower pixel region 121 of the logic chip 120.

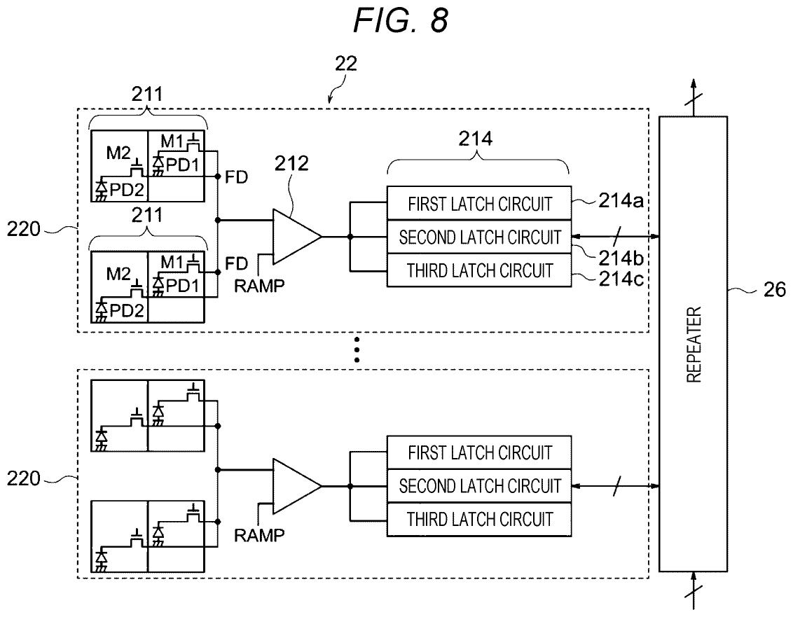

FIG. 8 is a block diagram illustrating a circuit configuration of a pixel according to Comparative Example 2. Also in FIG. 8, circuit elements similar to those of the pixel according to the first embodiment are denoted by the same reference signs, and a detailed description thereof will be omitted.

A pixel 220 illustrated in FIG. 8 is provided with two photoelectric conversion circuits 211. Furthermore, the pixel 220 does not include the selection circuit 213. Moreover, the storage circuit 214 includes the third latch circuit 214c in addition to the first latch circuit 214a and the second latch circuit 214b. However, in the pixel 220, the comparator 212 and the storage circuit 214 are shared by the two photoelectric conversion circuits 211. Thus, the number of comparators 212 and storage circuits 214 per pixel is reduced as compared with Comparative Example 1. As a result, a sufficient space for forming the storage circuit 214 can be secured in the lower pixel region 121 of the logic chip 120.

However, in the present comparative example, since the comparator 212 and the storage circuit 214 are shared, the number of times of digital conversion of the analog pixel signal SIG is increased as compared with Comparative Example 1. As a result, a signal processing speed decreases, focal plane distortion occurs, and a global shutter cannot be used.

Furthermore, even when the image-plane phase difference AF processing is unnecessary, an operation on the premise of sharing the comparator 212 and the storage circuit 214 is required.

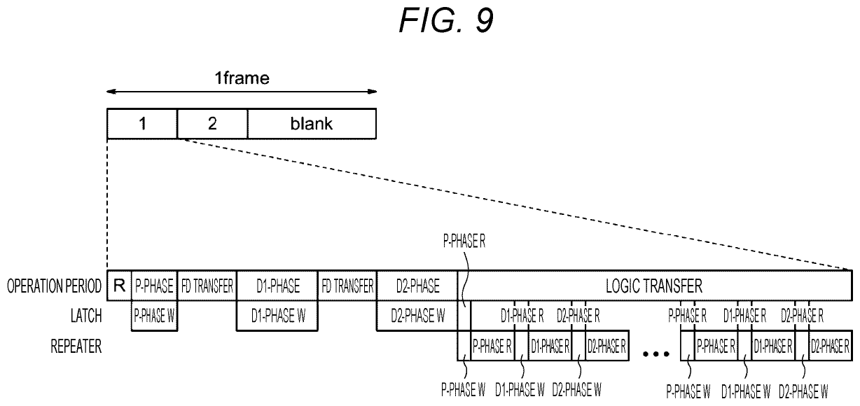

On the other hand, the switching circuit 215 is provided in the pixel 21a and the pixel 21b according to the present embodiment. The switching circuit 215 can select the storage circuits 214 of both the pixel 21a and the pixel 21b instead of selecting the storage circuit 214 of only one of the pixel 21a and the pixel 21b as the output destination of the output signal VCO of the comparator 212. Thus, the image-plane phase difference AF processing can be executed even if the storage circuit 214 of each pixel does not include the three latch circuits. Hereinafter, with reference to FIG. 9, a description will be given of an operation mode in which the image-plane phase difference AF processing is executed.

FIG. 9 is a timing chart for explaining an operation mode of the image-plane phase difference AF of the pixel 21 according to the first embodiment.

First, in a reset operation period R of the first pixel, a reset transistor (not illustrated) provided in the photoelectric conversion circuit 211 of the pixel 21a is turned on, on the basis of a reset signal from the pixel drive circuit 23. As a result, the potential of the floating diffusion layer FD of the photoelectric conversion circuit 211 is reset.

Next, in a reset period (P-phase), a first output signal VCO1 when the potential of the above floating diffusion layer FD is in a reset state is output from the comparator 212 of the pixel 21a. Subsequently, the selection circuit 213 of the pixel 21a selects the first latch circuit 214a as an output destination of the first output signal VCO1 on the basis of the selection signal from the pixel drive circuit 23. As a result, first data Coln1 of the first output signal VCO1 is written to the first latch circuit 214a (P-phase W). Thereafter, when the above reset transistor is turned off on the basis of the above reset signal, the reset state of the floating diffusion layer FD is released.

Next, in a charge transfer period (FD transfer), only the first photodiode PD1 of the pixel 21a photoelectrically converts the incident light. Subsequently, the first transfer transistor M1 of the pixel 21a is turned on, on the basis of the transfer signal from the pixel drive circuit 23. As a result, the charges accumulated in the first photodiode PD1 of the pixel 21a are transferred to the floating diffusion layer FD. Thereafter, the analog pixel signal SIG according to the amount of charges is generated in the floating diffusion layer FD.

Next, in a first data acquisition period (D1-phase), the comparator 212 of the pixel 21a compares the analog pixel signal SIG based on light reception by the first photodiode PD1 with the ramp signal RAMP, and outputs a second output signal VCO2. Subsequently, the selection circuit 213 of each pixel selects the second latch circuit 214b as an output destination of the second output signal VCO2 on the basis of the selection signal from the pixel drive circuit 23. As a result, second data Coln2 of the second output signal VCO2 is written to the second latch circuit 214b (D1-phase W).

Next, in a charge transfer period (FD transfer), both the first photodiode PD1 and the second photodiode PD2 of the pixel 21a photoelectrically convert the incident light. Subsequently, the first transfer transistor M1 and the second transfer transistor M2 of the pixel 21a are simultaneously turned on, on the basis of the transfer signal from the pixel drive circuit 23. As a result, the charges accumulated in the first photodiode PD1 and the second photodiode PD2 are transferred to the floating diffusion layer FD. Thereafter, the analog pixel signal SIG according to the amount of charges is generated in the floating diffusion layer FD.

Next, in a second data acquisition period (D2-phase), the comparator 212 of the pixel 21a compares the analog pixel signal SIG based on light reception by the first photodiode PD1 and the second photodiode PD2 with the ramp signal RAMP, and outputs a third output signal VCO3. Subsequently, the selection circuit 213 of each pixel selects the first latch circuit 214a of the pixel 21b as an output destination of the third output signal VCO3 on the basis of the selection signal from the pixel drive circuit 23. As a result, third data Coln3 of the third output signal VCO3 is written to the first latch circuit 214a of the pixel 21b (D2-phase W).

Next, in a logic transfer period, the first data Coln1 stored in the first latch circuit 214a is read by the repeater 26 (P-phase R) and written to the repeater 26 (P-phase W). The first data Coln1 written to the repeater 26 is read out to the output unit 27 (P-phase R).

Subsequently, the second data Coln2 stored in the second latch circuit 214b is read by the repeater 26 (D1-phase R) and written to the repeater 26 (D1-phase W). The second data Coln2 written to the repeater 26 is read out to the output unit 27 (D1-phase R).

Subsequently, the third data Coln3 stored in the first latch circuit 214a of the pixel 21b is read by the repeater 26 (D2-phase R) and written to the repeater 26 (D2-phase W). The third data Coln3 written to the repeater 26 is read out to the output unit 27 (D2-phase R). As a result, the image-plane phase difference AF processing for the pixel 21a ends. Thereafter, in the pixel 21b of the second pixel, the same operation as that of the pixel 21a described above is performed. In this case, the third data Coln3 of the third output signal VCO3 output from the comparator 212 of the pixel 21b is written to the first latch circuit 214a of the pixel 21a by the selection circuits 213 of the pixel 21a and the pixel 21b.

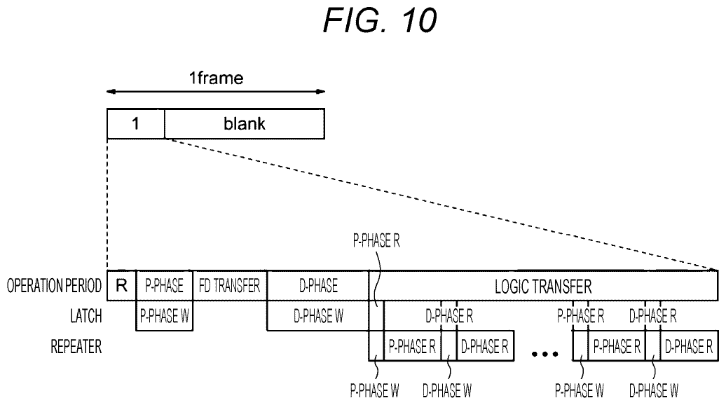

Next, with reference to FIG. 10, a description will be given of an operation mode in which the image-plane phase difference AF processing is not executed.

FIG. 10 is a timing chart for explaining the operation mode in which the image-plane phase difference AF processing by the pixel 21 according to the first embodiment is not executed.

First, in the reset operation period R, the reset transistor (not illustrated) provided in each of the photoelectric conversion circuits 211 of all the pixels including the pixel 21a and the pixel 21b is turned on, on the basis of the reset signal from the pixel drive circuit 23. As a result, the potential of the floating diffusion layer FD is reset.

Next, in the reset period (P-phase), the first output signals VCO1 when the potentials of the floating diffusion layers FD are in the reset states are respectively output from the comparators 212 of all the pixels. Subsequently, the selection circuits 213 of all the pixels each select the first latch circuit 214a as the output destination of the first output signal VCO1 on the basis of the selection signal from the pixel drive circuit 23. As a result, the first data Coln1 of the first output signals VCO1 of all the pixels each are written to the first latch circuit 214a (P-phase W). Thereafter, when the above reset transistor is turned off on the basis of the above reset signal, the reset state of the floating diffusion layer FD is released.

Next, in the charge transfer period (FD transfer), both the first photodiode PD1 and the second photodiode PD2 of the pixel 21a photoelectrically convert the incident light. Subsequently, the first transfer transistor M1 and the second transfer transistor M2 of the pixel 21a are turned on, on the basis of the transfer signal from the pixel drive circuit 23. As a result, the charges accumulated in the first photodiode PD1 and the second photodiode PD2 are transferred to the floating diffusion layer FD. Thereafter, the analog pixel signal SIG according to the amount of charges is generated in the floating diffusion layer FD.

Next, in a data acquisition period (D-phase), the comparators 212 of all the pixels each compare the analog pixel signal SIG based on the light reception by the first photodiode PD1 and the second photodiode PD2 with the ramp signal RAMP, and outputs the third output signal VCO3. Subsequently, the selection circuits 213 of all the pixels each select the second latch circuit 214b as the output destination of the third output signal VCO3 on the basis of the selection signal from the pixel drive circuit 23. As a result, the third data Coln3 of the third output signal VCO3 is written to the second latch circuit 214b (D-phase W).

Next, in a logic transfer period, the first data Coln1 stored in the first latch circuit 214a is read by the repeater 26 (P-phase R) and written to the repeater 26 (P-phase W). The first data Coln1 written to the repeater 26 is read out to the output unit 27 (P-phase R).

Subsequently, the third data Coln3 stored in the second latch circuit 214b is read by the repeater 26 (D-phase R) and written to the repeater 26 (D-phase W). The third data Coln3 written to the repeater 26 is read out to the output unit 27 (D-phase R).

According to the light detection element 1 according to the present embodiment configured as described above, since the latch circuit of the adjacent pixel is used in the operation mode in which the image-plane phase difference AF processing is executed, it is not necessary to provide three latch circuits for each pixel. As a result, since a sufficient space for forming the storage circuit 214 can be secured in the lower pixel region 121 of the logic chip 120, it is possible to suppress an increase in size of the storage circuit 214.

Furthermore, in the operation mode in which the image-plane phase difference AF processing is not executed, the comparator 212 and the storage circuit 214 are not shared between the pixel 21a and the pixel 21b, so that a decrease in signal processing speed can be suppressed. Note that, when the image-plane phase difference AF processing is executed, the repeater 26 thins out pixels from which the output signal VCO is read, whereby a decrease in signal processing speed can be suppressed.

### Second Embodiment

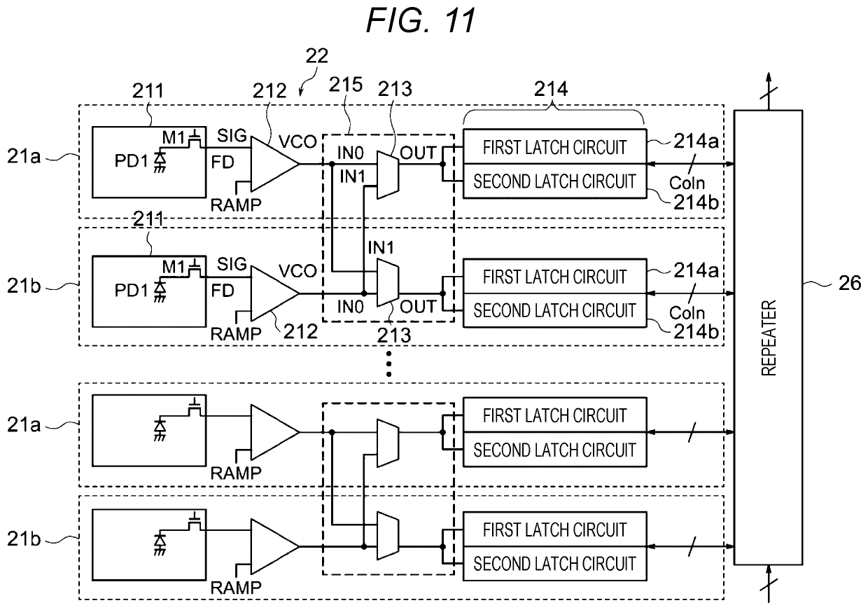

FIG. 11 is a block diagram illustrating an example of a circuit configuration of a pixel according to a second embodiment. In FIG. 11, the same reference signs are given to circuit elements similar to those of the pixel of the first embodiment described above, and a detailed description thereof will be omitted.

The present embodiment is different from the first embodiment in the configuration of the photoelectric conversion circuit 211. Specifically, the photoelectric conversion circuit 211 is provided with the first photodiode PD1 and the first transfer transistor M1, but is not provided with the second photodiode PD2 or the second transfer transistor M2. Note that the configurations of the comparator 212, the selection circuit 213, and the storage circuit 214 are the same as those of the first embodiment.

The pixel 21a and the pixel 21b according to the present embodiment may execute multiplex AD processing of continuously performing AD conversion processing of the analog pixel signal once transferred to the floating diffusion layer FD a plurality of times in the reset period and the data acquisition period according to an illuminance of a light detection target area.

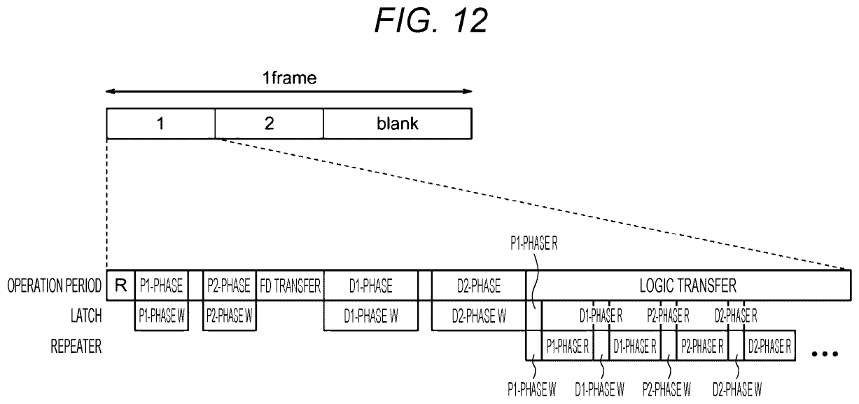

Hereinafter, with reference to FIG. 12, a description will be given of an operation mode in which multiplex AD processing is executed by the pixel according to the present embodiment.

FIG. 12 is a timing chart for explaining the multiplex AD processing by the pixel according to the second embodiment.

First, in the reset operation period R, the reset transistor (not illustrated) provided in the photoelectric conversion circuit 211 of the pixel 21a is turned on, on the basis of the reset signal from the pixel drive circuit 23. As a result, the potential of the floating diffusion layer FD is reset.

Next, in a first reset period (P1-phase), a first output signal VCO1a when the potential of the floating diffusion layer FD is in the reset state is output from the comparator 212 of the pixel 21a. The first latch circuit 214a of the pixel 21a is selected as an output destination of the first output signal VCO1a by operation of the selection circuits 213 of the pixel 21a and the pixel 21b based on the control by the pixel drive circuit 23. As a result, first data Coln1a of the first output signal VCO1a is written to the first latch circuit 214a of the pixel 21a (P1-phase W).

Next, in a second reset period (P2-phase), a first output signal VCO1b when the potential of the floating diffusion layer FD is in the reset state is output from the comparator 212 of the pixel 21a following the first output signal VCO1a. The first latch circuit 214a of the pixel 21b adjacent to the pixel 21a is selected as an output destination of the first output signal VCO1b by the operation of the selection circuits 213 of the pixel 21a and the pixel 21b based on the control by the pixel drive circuit 23. As a result, first data Coln1b of the first output signal VCO1b is written to the first latch circuit 214a of the pixel 21b (P2-phase W). Thereafter, when the reset transistor of the pixel 21a is turned off on the basis of the above reset signal, the reset state of the floating diffusion layer FD is released.

Next, in the charge transfer period (FD transfer), the first photodiode PD1 of the pixel 21a photoelectrically converts the incident light. Subsequently, the first transfer transistor M1 of the pixel 21a is turned on, on the basis of the transfer signal from the pixel drive circuit 23. When the first transfer transistor M1 is turned on, the charges accumulated in the first photodiode PD1 are transferred to the floating diffusion layer FD, and the analog pixel signal SIG is generated according to the amount of charges accumulated in the first photodiode PD1, in the floating diffusion layer FD.

Next, in the first data acquisition period (D1-phase), the comparator 212 compares the analog pixel signal SIG based on the first light reception by the first photodiode PD1 of the photoelectric conversion circuit 211 with the ramp signal RAMP, and outputs a second output signal VCO2a. The second latch circuit 214b of the pixel 21a is selected as an output destination of the second output signal VCO2a by the operation of the selection circuits 213 of the pixel 21a and the pixel 21b based on the control by the pixel drive circuit 23. As a result, second data Coln2a of the second output signal VCO2a is written to the second latch circuit 214b of the pixel 21a (D1-phase W).

Next, in the second data acquisition period (D2-phase), the comparator 212 compares the analog pixel signal SIG based on the second light reception subsequent to the first light reception by the first photodiode PD1 of the photoelectric conversion circuit 211 with the ramp signal RAMP, and outputs a second output signal VCO2b. The second latch circuit 214b of the pixel 21b is selected as the output destination of the second output signal VCO2b by the operation of the selection circuits 213 of the pixel 21a and the pixel 21b based on the control by the pixel drive circuit 23. As a result, second data Coln2b of the second output signal VCO2b is written to the second latch circuit 214b of the pixel 21b (D2-phase W).

Next, in the logic transfer period, the first data Colnla stored in the first latch circuit 214a of the pixel 21a is read by the repeater 26 (P1-phase R) and written to the repeater 26 (P-phase W). The first data Colnla written to the repeater 26 is read out to the output unit 27 (P1-phase R).

Subsequently, the second data Coln2a stored in the second latch circuit 214b of the pixel 21a is read by the repeater 26 (D1-phase R) and written to the repeater 26 (D1-phase W). The second data Coln2a written to the repeater 26 is read out to the output unit 27 (D1-phase R).

Subsequently, the first data Coln1b stored in the first latch circuit 214a of the pixel 21b is read by the repeater 26 (P2-phase R) and written to the repeater 26 (P2-phase W). The first data Coln1b written to the repeater 26 is read out to the output unit 27 (P2-phase R).

Subsequently, the second data Coln2b stored in the second latch circuit 214b of the pixel 21b is read by the repeater 26 (D2-phase R) and written to the repeater 26 (D2-phase W). The second data Coln2b written to the repeater 26 is read out to the output unit 27 (D2-phase R). As a result, the multiplex AD processing by the pixel 21a ends. Thereafter, in the pixel 21b, the same operation as that of the pixel 21a described above is performed. In this case, the first data Coln1a, the first data Coln1b, the second data Coln2a, and the second data Coln2b of the pixel 21b are written by the selection circuits 213 of the pixel 21a and the pixel 21b in the first latch circuit 214a of the pixel 21b, the first latch circuit 214a of the pixel 21a, the second latch circuit 214b of the pixel 21b, and the second latch circuit 214b of the pixel 21a, respectively.

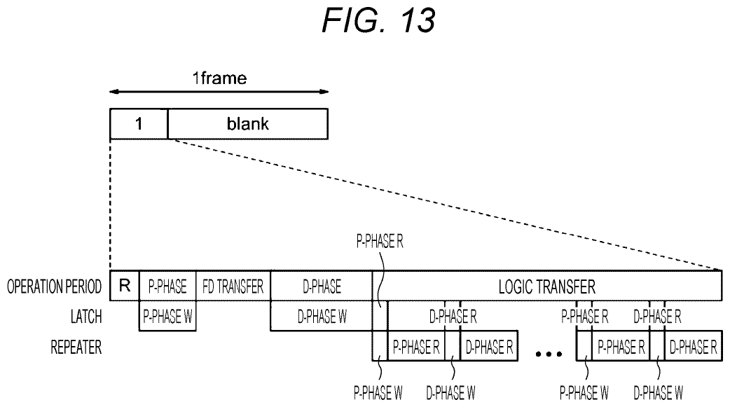

Next, with reference to FIG. 13, a description will be given of an operation mode in which the multiplex AD processing is not executed. FIG. 13 is a timing chart for explaining the operation mode in which the multiplex AD processing by the pixel according to the second embodiment is not executed.

First, in the reset operation period R, reset transistors (not illustrated) respectively provided in the photoelectric conversion circuits 211 of the pixel 21a and the pixel 21b are turned on, on the basis of the reset signal from the pixel drive circuit 23. As a result, the potentials of the floating diffusion layers FD of respective pixels are simultaneously reset.

Next, in the reset period (P-phase), the first output signals VCO1 when the potentials of the floating diffusion layers FD are in the reset states are simultaneously output from the comparators 212 of the pixel 21a and the pixel 21b. The first data Coln1 of the first output signal VCO1 output from the pixel 21a is written to the first latch circuit 214a of the pixel 21a, and the first data Coln1 of the first output signal VCO1 output from the pixel 21b is written to the first latch circuit 214a of the pixel 21b (P-phase W). Thereafter, when the above reset transistor is turned off on the basis of the above reset signal, the reset state of the floating diffusion layer FD is released.

Next, in the charge transfer period (FD transfer), the first photodiodes PD1 of the pixel 21a and the pixel 21b each photoelectrically convert the incident light. Subsequently, the first transfer transistors M1 of the respective pixels are simultaneously turned on, on the basis of the transfer signal from the pixel drive circuit 23. As a result, the charges accumulated in the first photodiodes PD1 are simultaneously transferred to the floating diffusion layers FD of the respective pixels. Thereafter, in each floating diffusion layer FD, the analog pixel signal SIG is generated according to the amount of charges accumulated in the first photodiode PD1.

Next, in the data acquisition period (D-phase), the comparator 212 of each pixel compares the analog pixel signal SIG based on the light reception by the first photodiode PD1 with the ramp signal RAMP, and outputs the second output signal VCO2. By the selection circuit 213 of each pixel, the second data Coln2 of the second output signal VCO2 output from the pixel 21a is written to the second latch circuit 214b of the pixel 21a, and the second data Coln2 of the second output signal VCO2 output from the pixel 21b is written to the second latch circuit 214b of the pixel 21b (D-phase W).

Next, in the logic transfer period, the first data Coln1 stored in the first latch circuit 214a of the pixel 21a is read by the repeater 26 (P-phase R) and written to the repeater 26 (P-phase W). The first data Coln1 written to the repeater 26 is read out to the output unit 27 (P1-phase R).

Subsequently, the second data Coln2 stored in the second latch circuit 214b of the pixel 21a is read by the repeater 26 (D-phase R) and written to the repeater 26 (D-phase W). The second data Coln2 written to the repeater 26 is read out to the output unit 27 (D-phase R). Thereafter, as in the pixel 21a, the first data Coln1 and the second data Coln2 respectively stored in the first latch circuit 214a and the second latch circuit 214b of the pixel 21b are read out to the output unit 27 via the repeater 26. As a result, the operation mode in which the multiplex AD processing is not executed ends.

Here, Comparative Example 3 to be compared with the second embodiment will be described.

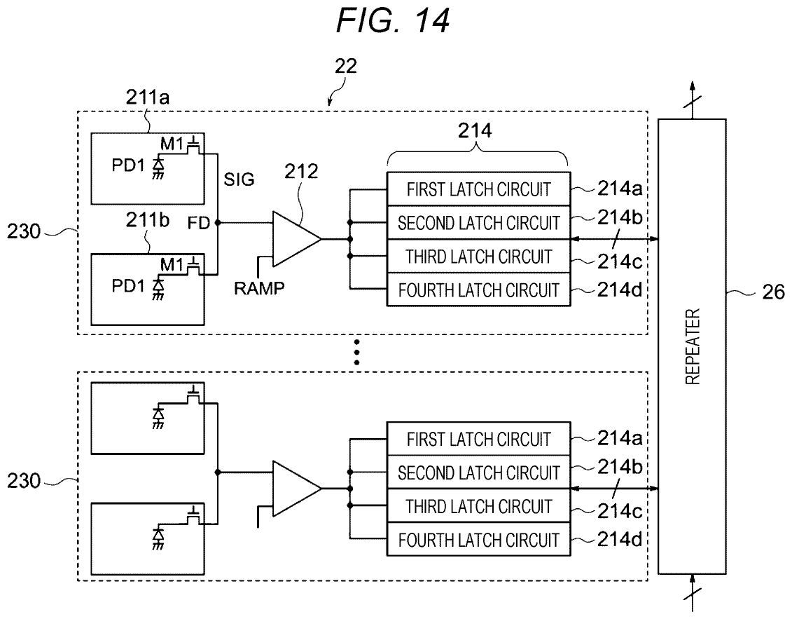

FIG. 14 is a block diagram illustrating a circuit configuration of a pixel according to Comparative Example 3. In FIG. 14, circuit elements similar to those of the pixel according to the present embodiment described above are denoted by the same reference signs, and a detailed description thereof will be omitted.

A pixel 230 illustrated in FIG. 14 is provided with a photoelectric conversion circuit 211a and a photoelectric conversion circuit 211b. Each photoelectric conversion circuit includes the first photodiode PD1 and the first transfer transistor M1. Furthermore, the pixel 230 does not include the selection circuit 213. Moreover, the storage circuit 214 includes the first latch circuit 214a, the second latch circuit 214b, the third latch circuit 214c, and a fourth latch circuit 214d to execute the multiplex AD processing. The comparator 212 and the storage circuit 214 are shared by the photoelectric conversion circuit 211a and the photoelectric conversion circuit 211b. Hereinafter, a description will be given of an operation mode in which the pixel 230 according to the present comparative example executes multiplex AD processing.

First, in the reset operation period R, a reset transistor (not illustrated) provided in the photoelectric conversion circuit 211a is turned on, on the basis of the reset signal from the pixel drive circuit 23. As a result, the potential of the floating diffusion layer FD is reset.

Next, in the first reset period (P1-phase), the first output signal VCO1a when the potential of the floating diffusion layer FD is in the reset state is output from the comparator 212. The first data Coln1a of the first output signal VCO1a is written to the first latch circuit 214a (P1-phase W).

Next, in the second reset period (P2-phase), as in the first reset period, the first output signal VCO1b when the potential of the floating diffusion layer FD is in the reset state is output from the comparator 212. The first data Coln1b of the first output signal VCO1b is written to the third latch circuit 214c (P2-phase W). Thereafter, when the above reset transistor is turned off on the basis of the above reset signal, the reset state of the floating diffusion layer FD is released.

Next, in the charge transfer period (FD transfer), the first photodiode PD1 of the photoelectric conversion circuit 211a photoelectrically converts the incident light a plurality of times. Subsequently, the first transfer transistor M1 of the photoelectric conversion circuit 211a is turned on, on the basis of the transfer signal from the pixel drive circuit 23, every time the first photodiode PD1 performs photoelectric conversion. Every time the first transfer transistor M1 is turned on, the charges accumulated in the first photodiode PD1 of the photoelectric conversion circuit 211a are transferred to the floating diffusion layer FD and converted into the analog pixel signal SIG according to the amount of charges.

Next, in the first data acquisition period (D1-phase), the comparator 212 compares a first analog pixel signal SIG1 generated on the basis of the first light reception by the first photodiode PD1 of the photoelectric conversion circuit 211a with the ramp signal RAMP, and outputs the second output signal VCO2a. The second data Coln2a of the second output signal VCO2a is written to the second latch circuit 214b (D1-phase W).

Next, in the second data acquisition period (D2-phase), the comparator 212 compares a second analog pixel signal SIG2 generated on the basis of the second light reception by the first photodiode PD1 of the photoelectric conversion circuit 211a with the ramp signal RAMP, and outputs the second output signal VCO2b. The second data Coln2b of the second output signal VCO2b is written to the fourth latch circuit 214d (D2-phase W).

Next, in the logic transfer period, the first data Coln1a stored in the first latch circuit 214a is read by the repeater 26 (P1-phase R) and written to the repeater 26 (P-phase W). The first data Coln1a written to the repeater 26 is read out to the output unit 27 (P1-phase R).

Subsequently, the second data Coln2a stored in the second latch circuit 214b is read by the repeater 26 (D1-phase R) and written to the repeater 26 (D1-phase W). The second data Coln2a written to the repeater 26 is read out to the output unit 27 (D1-phase R).

Subsequently, the first data Coln1b stored in the third latch circuit 214c is read by the repeater 26 (P2-phase R) and written to the repeater 26 (P2-phase W). The first data Coln1b written to the repeater 26 is read out to the output unit 27 (P2-phase R).

Subsequently, the second data Coln2b stored in the fourth latch circuit 214d is read by the repeater 26 (D2-phase R) and written to the repeater 26 (D2-phase W). The second data Coln2b written to the repeater 26 is read out to the output unit 27 (D2-phase R). As a result, the multiplex AD processing by the photoelectric conversion circuit 211a ends. Thereafter, the same operation as the photoelectric conversion circuit 211a described above is performed in the photoelectric conversion circuit 211b.

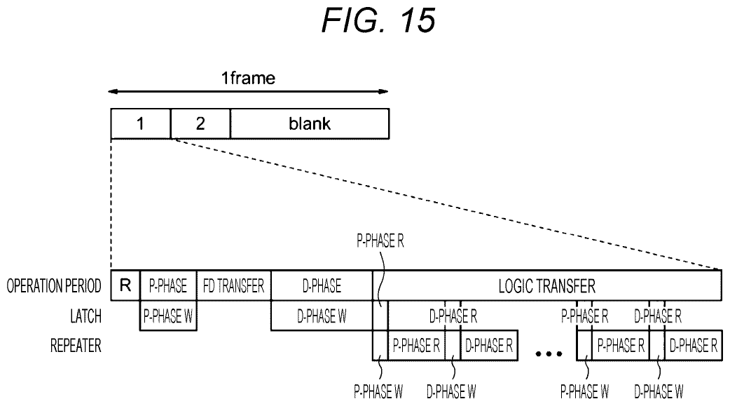

Next, with reference to FIG. 15, a description will be given of an operation mode in which the multiplex AD processing is not executed. FIG. 15 is a timing chart for explaining an operation mode in which the multiplex AD processing by the pixel according to Comparative Example 3 is not executed.

First, in the reset operation period R, the reset transistor (not illustrated) provided in the photoelectric conversion circuit 211a is turned on, on the basis of the reset signal from the pixel drive circuit 23, as in the operation mode in which the multiplex AD processing is executed. As a result, the potential of the floating diffusion layer FD is reset.

Next, in the reset period (P-phase), the first output signal VCO1a when the potential of the floating diffusion layer FD is in the reset state is output from the comparator 212. The first data Coln1a of the first output signal VCO1a is written to the first latch circuit 214a (P-phase W). Thereafter, when the above reset transistor is turned off on the basis of the above reset signal, the reset state of the floating diffusion layer FD is released.

Next, in the charge transfer period (FD transfer), the first photodiode PD1 of the photoelectric conversion circuit 211a photoelectrically converts the incident light.

Subsequently, the first transfer transistor M1 of the photoelectric conversion circuit 211a is turned on, on the basis of the transfer signal from the pixel drive circuit 23. As a result, the charges accumulated in the first photodiode PD1 are transferred to the floating diffusion layer FD. Thereafter, in the floating diffusion layer FD, the analog pixel signal SIG is generated according to the amount of charges accumulated in the first photodiode PD1.

Next, in the data acquisition period (D-phase), the comparator 212 compares the analog pixel signal SIG based on the light reception by the first photodiode PD1 with the ramp signal RAMP and outputs the second output signal VCO2a. The second data Coln2a of the second output signal VCO2a is written to the second latch circuit 214b (D-phase W).

Next, in the logic transfer period, the first data Coln1a stored in the first latch circuit 214a is read by the repeater 26 (P-phase R) and written to the repeater 26 (P-phase W). The first data Coln1a written to the repeater 26 is read out to the output unit 27 (P1-phase R).

Subsequently, the second data Coln2a stored in the second latch circuit 214b is read by the repeater 26 (D-phase R) and written to the repeater 26 (D-phase W). The second data Coln2a written to the repeater 26 is read out to the output unit 27 (D-phase R). Thereafter, the same operation as the photoelectric conversion circuit 211a described above is performed in the photoelectric conversion circuit 211b.

In the pixel 230 according to Comparative Example 3 configured as described above, four latch circuits are provided for the two photoelectric conversion circuits 211a and 211b. Thus, the signal processing speed in a case where the multiplex AD processing is executed is equivalent to that of the present embodiment.

However, in the pixel 230 according to Comparative Example 3, the comparator 212 is shared by the two photoelectric conversion circuits 211a and 211b. Thus, even in the operation mode in which the multiplex AD processing is unnecessary, as in the operation mode in which the multiplex AD processing is executed, it is necessary to perform the AD conversion processing on the analog pixel signals SIG of the photoelectric conversion circuit 211a and the photoelectric conversion circuit 211b at different timings. As a result, signal processing takes time.

On the other hand, in the above-described present embodiment, in the operation mode in which the multiplex AD processing is performed, by sharing the latch circuits of the pixel 21a and the pixel 21b adjacent to each other, it is possible to secure a signal processing speed equivalent to that of Comparative Example 3. Furthermore, in the present embodiment, the comparator 212 and the storage circuit 214 are not shared between the pixel 21a and the pixel 21b. Thus, in the operation mode in which the multiplex AD processing is not performed, the comparators 212 of the respective pixels can simultaneously perform the AD conversion processing on the analog pixel signals SIG generated in the respective photoelectric conversion circuits independently of each other. Thus, the signal processing can be speeded up as compared with Comparative Example 3.

Therefore, according to the present embodiment, it is possible to suppress a decrease in signal processing speed while implementing the multiplex AD processing.

### Third Embodiment

In the present embodiment, since the circuit configurations of the pixel 21a and the pixel 21b are the same as those of the second embodiment described above, the description thereof will be omitted.

The pixel 21a and the pixel 21b according to the present embodiment execute single-frame high dynamic range (HDR) processing of continuously performing AD conversion processing a plurality of times in the reset period and the data acquisition period according to the illuminance of the light detection target area.

The single-frame HDR processing is executed according to a timing chart (see FIG. 12) similar to the multiplex AD processing described in the second embodiment. However, in the multiplex AD processing, a light reception time of the first photodiode PD1 in the first data acquisition period (D1-phase) is the same as a light reception time of the first photodiode PD1 in the second data acquisition period (D2-phase). That is, an exposure time of the first photodiode PD1 is the same between the first data acquisition period and the second data acquisition period. On the other hand, in the single-frame HDR processing, the exposure time of the first photodiode PD1 in the first data acquisition period is different from the exposure time of the first photodiode PD1 in the second data acquisition period. For example, the exposure time in the second data acquisition period is longer than the exposure time in the first data acquisition period. In the present embodiment, the exposure time of the first photodiode PD1 is changed, whereby a dynamic range of the analog pixel signal SIG is expanded.

Furthermore, in the present embodiment, in an operation mode in which the single-frame HDR processing is performed, as in the multiplex AD processing described in the second embodiment, the latch circuits of the pixel 21a and the pixel 21b adjacent to each other are shared, whereby the signal processing speed can be secured. Furthermore, also in the present embodiment, as in the second embodiment, the comparator 212 and the storage circuit 214 are not shared between the pixel 21a and the pixel 21b. Thus, in an operation mode in which the single-frame HDR processing is not performed, the comparators 212 of the respective pixels can simultaneously perform the AD conversion processing on the analog pixel signals SIG generated in the respective photoelectric conversion circuits independently of each other. Thus, a decrease in the signal processing speed can be avoided.

Therefore, according to the present embodiment, it is possible to suppress a decrease in signal processing speed while implementing the single-frame HDR processing. Note that, in the present embodiment, the comparator 12 may perform AD conversion on the analog pixel signal SIG a plurality of times under a condition that a slope of the ramp signal is changed, without being limited to the exposure time of the first photodiode PD1.

### Fourth Embodiment

In the present embodiment, since the circuit configurations of the pixel 21a and the pixel 21b are the same as those of the second embodiment described above, the description thereof will be omitted.

The pixel 21a and the pixel 21b according to the present embodiment execute bit extension processing in order to improve image quality. Specifically, when the analog pixel signal SIG is converted into the digital pixel signal in the data acquisition period, in a case where a bit depth of the digital pixel signal is insufficient by one latch circuit, an adjacent latch circuit is also used. For example, in a case where the bit depth of the analog pixel signal SIG is 11 bits and the first latch circuit 214a can store up to 10 bits, the analog pixel signal SIG is stored not only in the first latch circuit 214a but also in the second latch circuit 214b adjacent to the first latch circuit 214a.

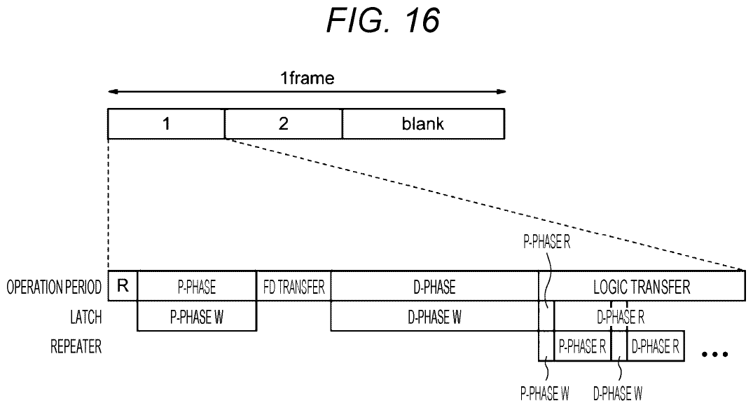

The bit extension processing will be described below with reference to FIG. 16. FIG. 16 is a timing chart for explaining the bit extension processing by a pixel according to a fourth embodiment.

First, in the reset operation period R, as in the multiplex AD processing described in the second embodiment, the reset transistor (not illustrated) provided in the photoelectric conversion circuit 211 of the pixel 21a is turned on, on the basis of the reset signal from the pixel drive circuit 23. As a result, the potential of the floating diffusion layer FD is reset.

Next, in the reset period (P-phase), the first output signal VCO1 when the potential of the floating diffusion layer FD is in the reset state is output from the comparator 212 of the pixel 21a. The first latch circuit 214a and the second latch circuit 214b of the pixel 21a are selected as output destinations of the first output signal VCO1 by the operation of the selection circuits 213 of the pixel 21a and the pixel 21b based on the control by the pixel drive circuit 23. As a result, a part of the first data Coln1 of the first output signal VCO1 is written to the first latch circuit 214a of the pixel 21a, and the remaining part of the first data Coln1 that cannot be stored in the first latch circuit 214a is written to the second latch circuit 214b of the pixel 21a (P1-phase W).

Next, in the charge transfer period (FD transfer), the first photodiode PD1 of the pixel 21a photoelectrically converts the incident light. Subsequently, the first transfer transistor M1 of the pixel 21a is turned on, on the basis of the transfer signal from the pixel drive circuit 23. As a result, the charges accumulated in the first photodiode PD1 are transferred to the floating diffusion layer FD. As a result, in the floating diffusion layer FD, the analog pixel signal SIG is generated according to the amount of charges accumulated in the first photodiode PD1.

Next, in the data acquisition period (D-phase), the comparator 212 compares the analog pixel signal SIG based on the light reception by the first photodiode PD1 of the photoelectric conversion circuit 211 with the ramp signal RAMP and outputs the second output signal VCO2.

The first latch circuit 214a and the second latch circuit 214b of the pixel 21b are selected as output destinations of the second output signal VCO2 by the operation of the selection circuits 213 of the pixel 21a and the pixel 21b based on the control by the pixel drive circuit 23. As a result, a part of the second data Coln2 of the second output signal VCO2 is written to the first latch circuit 214a of the pixel 21b, and the remaining part of the second data Coln2 that cannot be stored in the first latch circuit 214a is written to the second latch circuit 214b of the pixel 21b (D-phase W).

Next, in the logic transfer period, the first data Coln1 stored in the first latch circuit 214a and the second latch circuit 214b of the pixel 21a is read by the repeater 26 (P-phase R) and written to the repeater 26 (P-phase W). The first data Coln1a written to the repeater 26 is read out to the output unit 27 (P-phase R).

Subsequently, the second data Coln2 stored in the first latch circuit 214a and the second latch circuit 214b of the pixel 21b is read by the repeater 26 (D-phase R) and written to the repeater 26 (D-phase W). The second data Coln2 written to the repeater 26 is read out to the output unit 27 (D-phase R).

In an operation mode in which the bit extension processing is not executed, the pixel 21a and the pixel 21b operate according to the timing chart illustrated in FIG. 13 described in the second embodiment, and thus, a detailed description thereof will be omitted.

According to the present embodiment described above, the storage circuit 214 is shared between the pixel 21a and the pixel 21b by the selection circuits 213. Thus, even if the bit depth of the second output signal generated in the data acquisition period increases, the second output signal can be stored in the storage circuit 214. As a result, bit extension processing can be implemented.

Furthermore, in the operation mode in which the bit extension processing is not executed, the comparators 212 of the respective pixels perform the AD conversion processing independently of each other, and thus, a decrease in signal processing speed can be avoided. Therefore, the signal processing speed can be secured regardless of the necessity of the bit extension processing.

### Fifth Embodiment

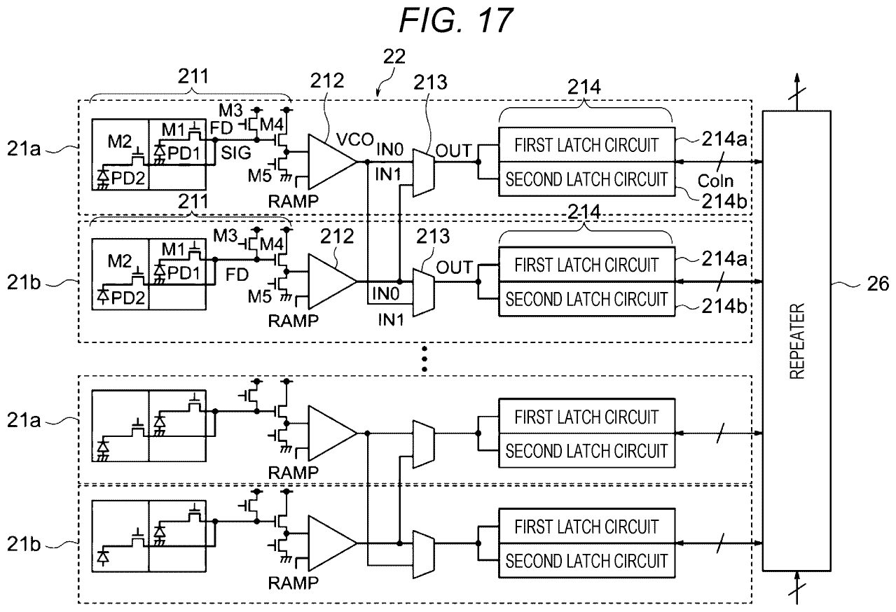

FIG. 17 is a block diagram illustrating an example of a circuit configuration of a pixel according to a fifth embodiment. In FIG. 17, the same reference signs are given to circuit elements similar to those of the pixel of the first embodiment described above, and a detailed description thereof will be omitted.

The present embodiment is different from the first embodiment in the configuration of the photoelectric conversion circuit 211. The photoelectric conversion circuit 211 of the present embodiment newly includes an amplifier transistor M4 and a current source transistor M5 in addition to the first photodiode PD1, the second photodiode PD2, the first transfer transistor M1, the second transfer transistor M2, and a reset transistor M3. The reset transistor M3, the amplifier transistor M4, and the current source transistor M5 each include, for example, an N-channel MOS transistor.

The amplifier transistor M4 and the current source transistor M5 connected in series function as a source follower circuit that amplifies the analog pixel signal SIG generated in the floating diffusion layer FD. The gate of the amplifier transistor M4 is connected to the floating diffusion layer FD and the source of the reset transistor M3. The drain of the amplifier transistor M4 is connected to a power supply line having a potential of a power supply voltage, similarly to the drain of the reset transistor M3. The source of the amplifier transistor M4 is connected to the drain of the current source transistor M5. The source of the current source transistor M5 is grounded.

A gate voltage of the current source transistor M5 is controlled by the pixel drive circuit 23. A current flowing between the drain and the source of the amplifier transistor M4 can be adjusted according to the gate voltage.

The pixel 21a and the pixel 21b according to the present embodiment configured as described above are also driven in the operation mode in which the image-plane phase difference AF processing is executed and the operation mode in which the image-plane phase difference AF processing is not executed according to the timing chart described in the first embodiment.

However, in the present embodiment, in the data acquisition period, the comparator 212 outputs a result of comparison between the analog pixel signal SIG amplified by the amplifier transistor M4 and the ramp signal RAMP as the output signal VCO.

According to the present embodiment described above, at the time of the operation mode in which the image-plane phase difference AF processing is executed, the latch circuit of the adjacent pixel is used as in the first embodiment, so that it is not necessary to provide three latch circuits for each pixel. As a result, it is possible to suppress an increase in size of the storage circuit 214.

Furthermore, also at the time of the operation mode in which the image-plane phase difference AF processing is not executed, the comparator 212 and the storage circuit 214 are not shared between the pixels as in the first embodiment, so that a decrease in signal processing speed can be suppressed.

Note that the amplifier transistor M4 and the current source transistor M5 described in the present embodiment can also be applied to the second to fourth embodiments described above. That is, the amplifier transistor M4 and the current source transistor M5 may be provided in the photoelectric conversion circuit 211 described in each of the second to fourth embodiments.

### Sixth Embodiment

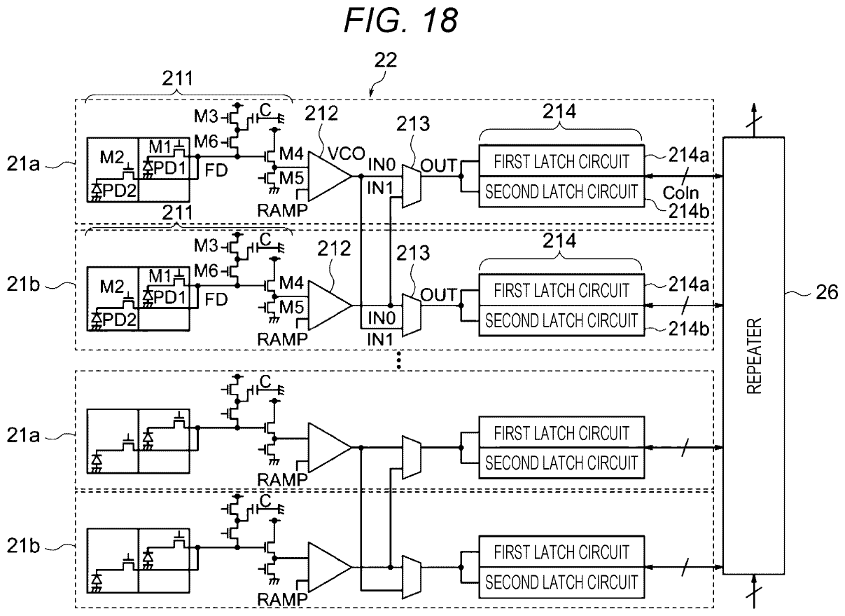

FIG. 18 is a block diagram illustrating an example of a circuit configuration of a pixel according to a sixth embodiment. In FIG. 18, the same reference signs are given to circuit elements similar to those of the pixel of the fifth embodiment described above, and a detailed description thereof will be omitted.

The present embodiment is different from the fifth embodiment in the configuration of the photoelectric conversion circuit 211. The photoelectric conversion circuit 211 of the present embodiment newly includes a conversion efficiency switching transistor M6 and a capacitive element C in addition to the circuit elements described in the fifth embodiment. The conversion efficiency switching transistor M6 and the capacitive element C constitute a conversion efficiency switching circuit that converts photoelectric conversion efficiencies of the first photodiode PD1 and the second photodiode PD2.

The conversion efficiency switching transistor M6 includes, for example, an N-channel MOS transistor. The drain of the conversion efficiency switching transistor M6 is connected to the source of the reset transistor M3. The source of the conversion efficiency switching transistor M6 is connected to the floating diffusion layer FD and the gate of the amplifier transistor M4. A switching signal is input from the pixel drive circuit 23 to the gate of the conversion efficiency switching transistor M6. Meanwhile, the capacitive element C is connected between the drain of the conversion efficiency switching transistor M6 and GND.

In the pixel 21a and the pixel 21b according to the present embodiment configured as described above, when the conversion efficiency switching transistor M6 is turned on, on the basis of the above switching signal at the time of the reset operation period R, a current flows through the reset transistor M3 and the conversion efficiency switching transistor M6, so that conversion efficiencies of the first photodiode PD1 and the second photodiode PD2 decrease. On the other hand, when the conversion efficiency switching transistor M6 is turned off on the basis of the above switching signal, a current flows through the reset transistor M3 and the capacitive element C, so that the conversion efficiencies of the first photodiode PD1 and the second photodiode PD2 increase.

Furthermore, also in the present embodiment, according to the timing chart described in the first embodiment, driving is performed in the operation mode in which the image-plane phase difference AF processing is executed and in the operation mode in which the image-plane phase difference AF processing is not executed. At this time, in the data acquisition period, as in the fifth embodiment, the comparator 212 outputs a result of comparison between the analog pixel signal SIG amplified by the amplifier transistor M4 and the ramp signal RAMP as the output signal VCO.

According to the present embodiment described above, at the time of the operation mode in which the image-plane phase difference AF processing is executed, the latch circuit of the adjacent pixel is used as in the first embodiment, so that it is not necessary to provide three latch circuits for each pixel. As a result, it is possible to suppress an increase in size of the storage circuit 214.

Furthermore, also at the time of the operation mode in which the image-plane phase difference AF processing is not executed, the comparator 212 and the storage circuit 214 are not shared between the pixels as in the first embodiment, so that a decrease in signal processing speed can be suppressed.

Note that the conversion efficiency switching transistor M6 and the capacitive element C described in the present embodiment can also be applied to the second to fourth embodiments described above. That is, the conversion efficiency switching transistor M6 and the capacitive element C may be provided in the photoelectric conversion circuit 211 described in each of the second to fourth embodiments.

### Seventh Embodiment

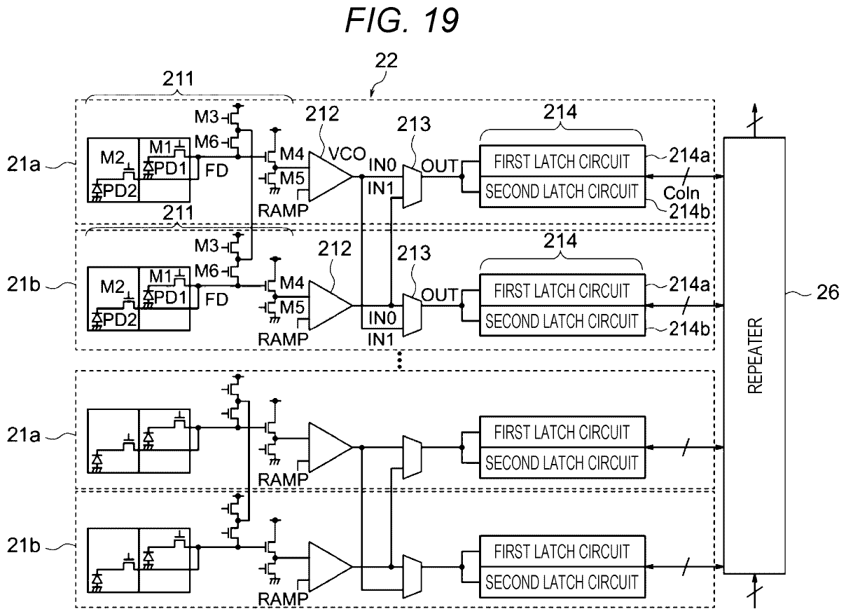

FIG. 19 is a block diagram illustrating an example of a circuit configuration of a pixel according to a seventh embodiment. In FIG. 19, the same reference signs are given to circuit elements similar to those of the pixel of the sixth embodiment described above, and a detailed description thereof will be omitted. In FIG. 19, the capacitive element C is not illustrated.

In the present embodiment, the conversion efficiency switching circuit of the pixel 21a and the conversion efficiency switching circuit of the pixel 21b are connected to each other. That is, connection points of the reset transistor M3 and the conversion efficiency switching transistor M6 are connected together between the pixel 21a and the pixel 21b.

In the pixel 21a and the pixel 21b according to the present embodiment configured as described above, the conversion efficiencies of the first photodiode PD1 and the second photodiode PD2 can be switched between high and low as in the above-described sixth embodiment.

Furthermore, also in the present embodiment, according to the timing chart described in the first embodiment, driving is performed in the operation mode in which the image-plane phase difference AF processing is executed and in the operation mode in which the image-plane phase difference AF processing is not executed. At this time, in the data acquisition period, as in the sixth embodiment, the comparator 212 outputs a result of comparison between the analog pixel signal SIG amplified by the amplifier transistor M4 and the ramp signal RAMP as the output signal VCO. Moreover, in the present embodiment, the charges transferred to the floating diffusion layer FD of the pixel 21a and the charges transferred to the floating diffusion layer FD of the pixel 21b can be added together.

According to the present embodiment described above, at the time of the operation mode in which the image-plane phase difference AF processing is executed, the latch circuit of the adjacent pixel is used as in the first embodiment, so that it is not necessary to provide three latch circuits for each pixel. As a result, it is possible to suppress an increase in size of the storage circuit 214.

Furthermore, also at the time of the operation mode in which the image-plane phase difference AF processing is not executed, the comparator 212 and the storage circuit 214 are not shared between the pixels as in the first embodiment, so that a decrease in signal processing speed can be suppressed.

Note that the configuration in which the conversion efficiency switching circuit of the pixel 21a and the conversion efficiency switching circuit of the pixel 21b are connected to each other can also be applied to the second to fourth embodiments described above. That is, connection points of the reset transistor M3 and the conversion efficiency switching transistor M6 may be connected together between the pixel 21a and the pixel 21b.

### Eighth Embodiment

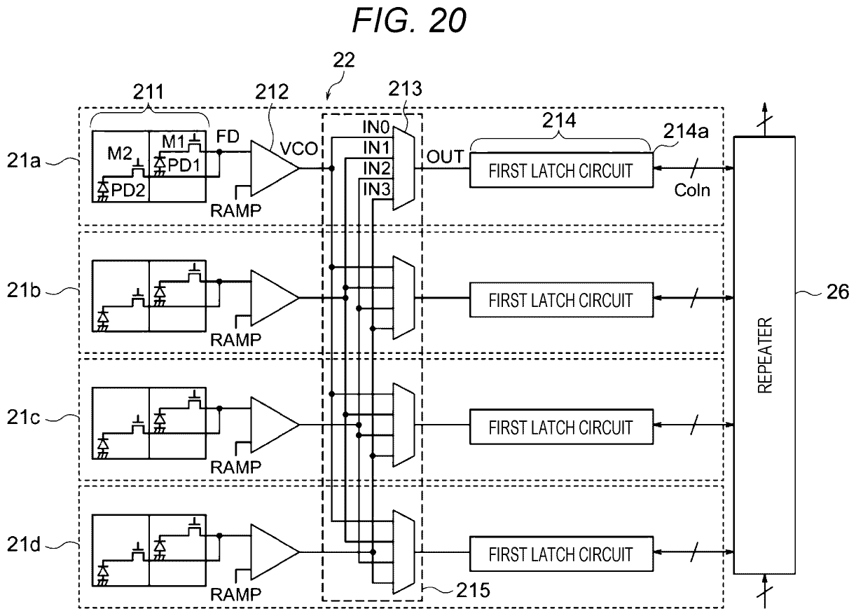

FIG. 20 is a block diagram illustrating an example of a circuit configuration of a pixel according to an eighth embodiment. In FIG. 20, the same reference signs are given to circuit elements similar to those of the pixel of the first embodiment described above, and a detailed description thereof will be omitted. The present embodiment is different from the first embodiment in the configurations of the selection circuit 213 and the storage circuit 214.

In the first embodiment described above, the storage circuit 214 can be shared between the pixel 21a and the pixel 21b adjacent to the pixel 21a by the switching circuit 215. Thus, the selection circuit 213 includes two input terminals IN0 and IN1. The input terminal IN0 of the pixel 21a is connected to the output terminal of the comparator 212 and the input terminal IN1 of the selection circuit 213 of the pixel 21b. The input terminal IN1 of the pixel 21a is connected to the input terminal IN0 of the selection circuit 213 of the pixel 21b.

On the other hand, in the present embodiment illustrated in FIG. 20, the storage circuit 214 can be shared among four pixels 21a to 21d arranged close to each other by the switching circuit 215 including four selection circuits 213. Thus, the storage circuit 214 includes only the first latch circuit 214a. That is, in the present embodiment, the first latch circuit 214a provided in each of the four pixels 21a to 21d can be shared. Among these four pixels, the pixel 21c and the pixel 21d are arranged around the pixel 21a and the pixel 21b.

In the present embodiment, the selection circuit 213 of each pixel has four input terminals IN0 to IN3. Each input terminal is connected to any one of the input terminals of the other selection circuits 213. Furthermore, in each selection circuit 213, any one of the four input terminals IN0 to IN3 is connected to the output terminal of the comparator 212.

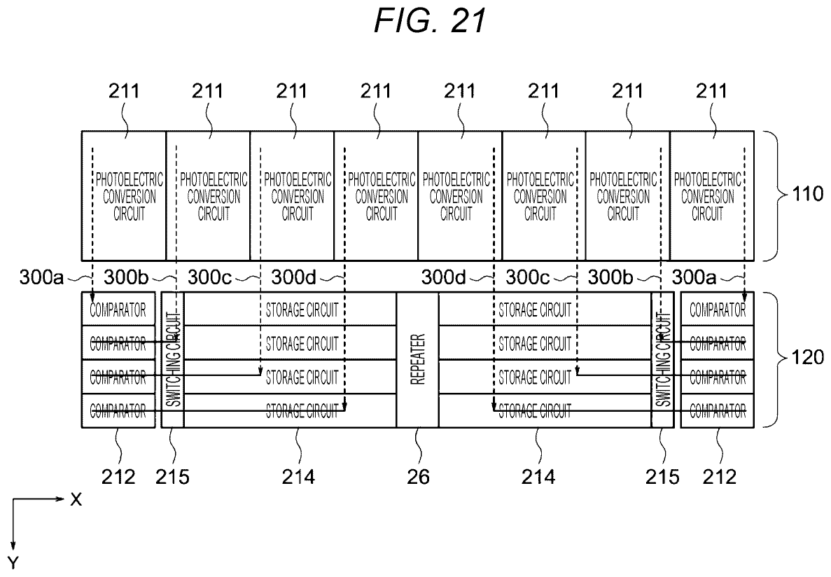

FIG. 21 is a diagram illustrating a layout example of pixels according to the eighth embodiment. Also in the present embodiment, as in the layout illustrated in FIG. 5, the repeater 26 is arranged at the position facing the center of the eight photoelectric conversion circuits 211. Furthermore, the comparators 212, the switching circuits 215, and the storage circuits 214 are arranged symmetrically with the repeater 26 interposed in the row direction X.

In the present embodiment, some operation modes can be set according to the number of pixels sharing the first latch circuit 214a among the pixels 21a to 21d. Here, a description will be given of some operation modes executed in the pixel according to the present embodiment.

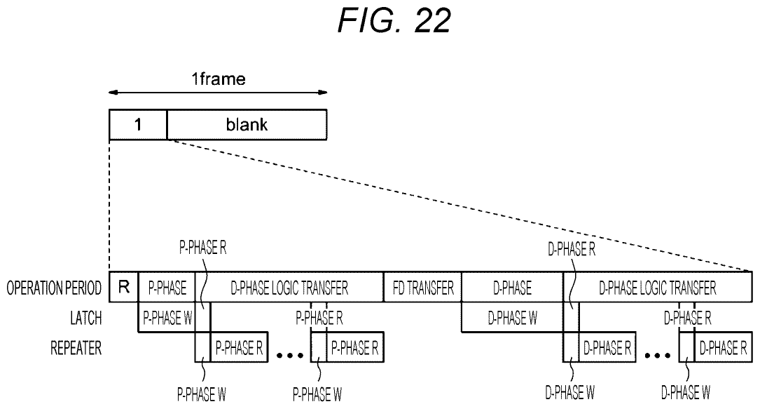

FIG. 22 is a timing chart for explaining an operation mode when the number of pixels sharing the first latch circuit 214a is set to zero. That is, FIG. 22 is a timing chart of global shutter processing in which the comparators 212 and the first latch circuits 214a of the respective pixels operate independently.

First, in the reset operation period R, reset transistors (not illustrated) respectively provided in the photoelectric conversion circuits 211 of the pixels 21a to 21d are turned on, on the basis of the reset signal from the pixel drive circuit 23. As a result, the potential of the floating diffusion layer FD is reset.

Next, in the reset period (P-phase), the first output signals VCO1 when the potentials of the floating diffusion layers FD are in the reset states are simultaneously output from the comparators 212 of the respective pixels. The first latch circuits 214a of the respective pixels are selected as output destinations of the first output signals VCO1 by the operation of the selection circuits 213 of the respective pixels based on the control by the pixel drive circuit 23. As a result, pieces of the first data Coln1 of the first output signals VCO1 are simultaneously written to the first latch circuits 214a of the respective pixels (P-phase W).

Next, in the P-phase logic transfer period, the pieces of the first data Coln1 stored in the first latch circuits 214a of the respective pixels are sequentially read to the repeater 26 (P-phase R) and written to the repeater 26 (P-phase W). The pieces of the first data Coln1 written to the repeater 26 are sequentially read out to the output unit 27 (P-phase R).

Next, in the charge transfer period (FD transfer), the first photodiode PD1 and the second photodiode PD2 of the photoelectric conversion circuit 211 of each pixel photoelectrically convert the incident light. Subsequently, the first transfer transistor M1 and the second transfer transistor M2 of each photoelectric conversion circuit 211 are simultaneously turned on, on the basis of the transfer signal from the pixel drive circuit 23. As a result, the charges accumulated in the first photodiode PD1 and the second photodiode PD2 are transferred to the floating diffusion layer FD and converted into the analog pixel signal SIG according to the amount of charges.

Next, in the data acquisition period (D-phase), the comparator 212 of each pixel compares the analog pixel signal SIG based on the light reception by the first photodiode PD1 and the second photodiode PD2 with the ramp signal RAMP, and outputs the second output signal VCO2. The first latch circuits 214a of the respective pixels are selected as output destinations of the second output signals VCO2 by the operation of the selection circuits 213 of the respective pixels based on the control by the pixel drive circuit 23. As a result, pieces of the second data Coln2 of the second output signals VCO2 are simultaneously written to the first latch circuits 214a of the respective pixels (D-phase W).

Next, in the D-phase logic transfer period, the pieces of the second data Coln2 stored in the first latch circuits 214a of the respective pixels are sequentially read to the repeater 26 (D-phase R) and written to the repeater 26 (D-phase W). The pieces of the second data Coln2 written to the repeater 26 are sequentially read out to the output unit 27 (D-phase R). As a result, the global shutter processing ends.

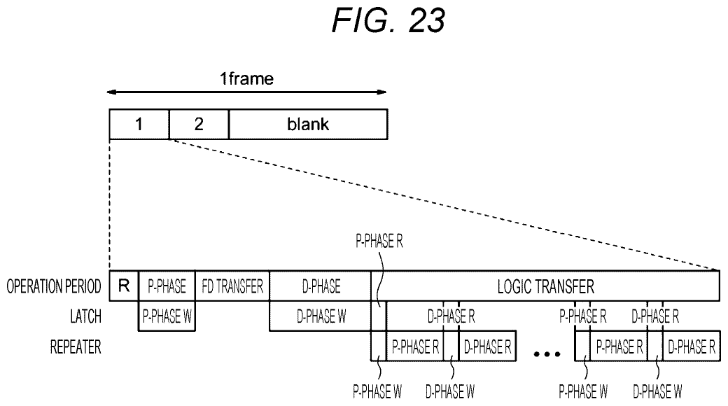

FIG. 23 is a timing chart for explaining an operation mode when the number of pixels sharing the first latch circuit 214a is set to two. That is, FIG. 23 is a timing chart of an operation mode in which one first latch circuit 214a is shared between the pixel 21a and the pixel 21b and one first latch circuit 214a is shared between the pixel 21c and the pixel 21d.

First, in the reset operation period R, reset transistors (not illustrated) respectively provided in the photoelectric conversion circuits 211 of the pixel 21a and the pixel 21c are turned on, on the basis of the reset signal from the pixel drive circuit 23. As a result, the potential of the floating diffusion layer FD is reset.

Next, in the reset period (P-phase), the first output signals VCO1 when the potentials of the floating diffusion layers FD are in the reset states are simultaneously output from the comparators 212 of the pixel 21a and the pixel 21c. The first latch circuit 214a of the pixel 21a is selected as the output destination of the first output signal VCO1 output from the comparator 212 of the pixel 21a by the selection circuit 213 of each pixel. As a result, the first data Coln1 of the first output signal VCO1 is written to the first latch circuit 214a of the pixel 21a (P-phase W). At the same time, the first latch circuit 214a of the pixel 21c is selected as the output destination of the first output signal VCO1 output from the comparator 212 of the pixel 21c by the selection circuit 213 of each pixel. As a result, the first data Coln1 of the first output signal VCO1 is written to the first latch circuit 214a of the pixel 21c (P-phase W).

Next, in the charge transfer period (FD transfer), the first photodiode PD1 and the second photodiode PD2 provided in the photoelectric conversion circuit 211 of each of the pixel 21a and the pixel 21c photoelectrically convert the incident light. Subsequently, the first transfer transistor M1 and the second transfer transistor provided in the photoelectric conversion circuit 211 of each of the pixel 21a and the pixel 21c are simultaneously turned on, on the basis of the transfer signal from the pixel drive circuit 23. As a result, in each of the pixel 21a and the pixel 21c, the charges accumulated in the first photodiode PD1 and the second photodiode PD2 are transferred to the floating diffusion layer FD, and converted into the analog pixel signal SIG according to the amount of charges.

Next, in the data acquisition period (D-phase), the comparators 212 of the pixel 21a and the pixel 21c each compare the analog pixel signal SIG based on the light reception by the first photodiode PD1 and the second photodiode PD2 with the ramp signal RAMP, and output the second output signal VCO2. The first latch circuit 214a of the pixel 21b is selected as the output destination of the second output signal VCO2 output from the comparator 212 of the pixel 21a by the operation of the selection circuit 213 of each pixel based on the control by the pixel drive circuit 23. As a result, the second data Coln2 of the second output signal VCO2 is simultaneously written to the first latch circuit 214a of the pixel 21b (D-phase W). At the same time, the first latch circuit 214a of the pixel 21d is selected as the output destination of the second output signal VCO2 output from the comparator 212 of the pixel 21c by the operation of the selection circuit 213 of each pixel based on the control by the pixel drive circuit 23. As a result, the second data Coln2 of the second output signal VCO2 is written to the first latch circuit 214a of the pixel 21d (D-phase W).

Next, in the logic transfer period, the first data Coln1 stored in the first latch circuit 214a of the pixel 21a is read by the repeater 26 (P-phase R) and written to the repeater 26 (P-phase W). The first data Coln1 written to the repeater 26 is read out to the output unit 27 (P-phase R).

Subsequently, the second data Coln2 stored in the first latch circuit 214a of the pixel 21b is read by the repeater 26 (D-phase R) and written to the repeater 26 (D-phase W). The second data Coln2 written to the repeater 26 is read out to the output unit 27 (D-phase R).

Subsequently, the first data Coln1 stored in the first latch circuit 214a of the pixel 21c is read by the repeater 26 (P-phase R) and written to the repeater 26 (P-phase W). The first data Coln1 written to the repeater 26 is read out to the output unit 27 (P-phase R).

Subsequently, the second data Coln2 stored in the first latch circuit 214a of the pixel 21d is read by the repeater 26 (D-phase R) and written to the repeater 26 (D-phase W). The second data Coln2 written to the repeater 26 is read out to the output unit 27 (D-phase R). Thereafter, in the pixel 21b and the pixel 21d, the same operation as that in the pixel 21a and the pixel 21c described above is performed. In this case, the second data Coln2 of the second output signal VCO2 output from the comparator 212 of the pixel 21b is stored in the first latch circuit 214a of the pixel 21a. At the same time, the second data Coln2 of the second output signal VCO2 output from the comparator 212 of the pixel 21d is stored in the first latch circuit 214a of the pixel 21c.

According to the operation mode described above, in each pixel, since the first output signal VCO1 in the reset period (P-phase) and the second output signal VCO2 in the data acquisition period (D-phase) are continuously sampled, the image quality can be improved.

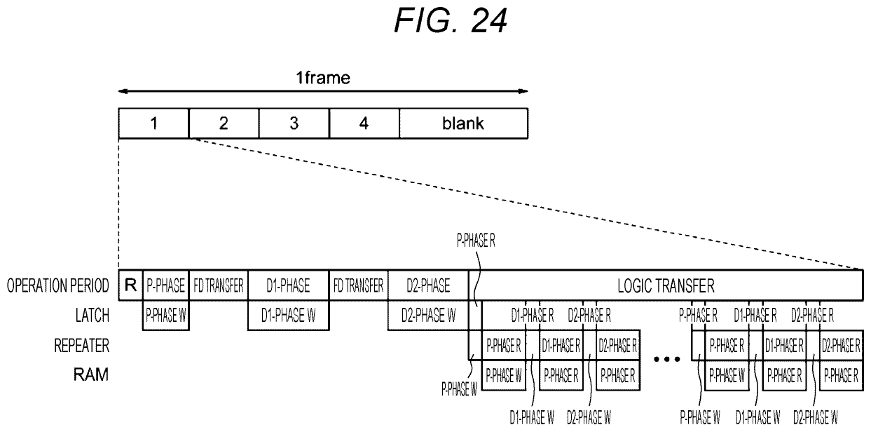

FIG. 24 is a timing chart for explaining the operation mode of the image-plane phase difference AF processing when the number of pixels sharing the first latch circuit 214a is set to four. That is, FIG. 24 is a timing chart of the image-plane phase difference AF processing in which the first latch circuit 214a is shared among the four pixels 21a to 21d.

First, in the reset operation period R of the first pixel, the reset transistor (not illustrated) provided in the photoelectric conversion circuit 211 of the pixel 21a is turned on, on the basis of the reset signal from the pixel drive circuit 23. As a result, the potential of the floating diffusion layer FD of the photoelectric conversion circuit 211 is reset.

Next, in the reset period (P-phase), the first output signal VCO1 when the potential of the above floating diffusion layer FD is in the reset state is output from the comparator 212 of the pixel 21a. Subsequently, the selection circuit 213 of each pixel selects the first latch circuit 214a of the pixel 21a as the output destination of the first output signal VCO1 on the basis of the selection signal from the pixel drive circuit 23.

As a result, the first data Coln1 of the first output signal VCO1 is written to the first latch circuit 214a (P-phase W). Thereafter, when the above reset transistor is turned off on the basis of the above reset signal, the reset state of the floating diffusion layer FD is released.

Next, in the charge transfer period (FD transfer), only the first photodiode PD1 of the pixel 21a photoelectrically converts the incident light. Subsequently, the first transfer transistor M1 of the pixel 21a is turned on, on the basis of the transfer signal from the pixel drive circuit 23. As a result, the charges accumulated in the first photodiode PD1 of the pixel 21a are transferred to the floating diffusion layer FD. Thereafter, the analog pixel signal SIG according to the amount of charges is generated in the floating diffusion layer FD.

Next, in the first data acquisition period (D1-phase), the comparator 212 of the pixel 21a compares the analog pixel signal SIG based on the light reception by the first photodiode PD1 with the ramp signal RAMP, and outputs the second output signal VCO2. Subsequently, the selection circuit 213 of each pixel selects the first latch circuit 214a of the pixel 21b as the output destination of the second output signal VCO2 on the basis of the selection signal from the pixel drive circuit 23. As a result, the second data Coln2 of the second output signal VCO2 is written to the first latch circuit 214a of the pixel 21b (D1-phase W).

Next, in the charge transfer period (FD transfer), both the first photodiode PD1 and the second photodiode PD2 of the pixel 21a photoelectrically convert the incident light. Subsequently, the first transfer transistor M1 and the second transfer transistor M2 of the pixel 21a are simultaneously turned on, on the basis of the transfer signal from the pixel drive circuit 23. As a result, the charges accumulated in the first photodiode PD1 and the second photodiode PD2 are transferred to the floating diffusion layer FD. Thereafter, the analog pixel signal SIG according to the amount of charges is generated in the floating diffusion layer FD.

Next, in the second data acquisition period (D2-phase), the comparator 212 of the pixel 21a compares the analog pixel signal SIG based on the light reception by the first photodiode PD1 and the second photodiode PD2 with the ramp signal RAMP, and outputs the third output signal VCO3. Subsequently, the selection circuit 213 of each pixel selects the first latch circuit 214a of the pixel 21c as a storage destination of the third output signal VCO3 on the basis of the selection signal from the pixel drive circuit 23. As a result, the third data Coln3 of the third output signal VCO3 is written to the first latch circuit 214a of the pixel 21c (D2-phase W).

Next, in the logic transfer period, the first data Coln1 stored in the first latch circuit 214a of the pixel 21a is read by the repeater 26 (P-phase R) and written to the repeater 26 (P-phase W). The first data Coln1 written to the repeater 26 is read out to the output unit 27 (P-phase R).

Subsequently, the second data Coln2 stored in the first latch circuit 214a of the pixel 21b is read by the repeater 26 (D1-phase R) and written to the repeater 26 (D1-phase W). The second data Coln2 written to the repeater 26 is read out to the output unit 27 (D1-phase R).

Subsequently, the third data Coln3 stored in the first latch circuit 214a of the pixel 21c is read by the repeater 26 (D2-phase R) and written to the repeater 26 (D2-phase W). The third data Coln3 written to the repeater 26 is read out to the output unit 27 (D2-phase R). As a result, operation of reading the data acquired by the pixel 21a ends. Thereafter, in the pixel 21b, the same operation as that of the pixel 21a described above is performed. In this case, the third data Coln3 of the third output signal VCO3 output from the comparator 212 of the pixel 21b is written to the first latch circuit 214a of the pixel 21a by the selection circuits 213 of the pixel 21a and the pixel 21b. As a result, the image-plane phase difference AF processing for the pixel 21a ends.

Thereafter, in each of the pixel 21b of the second pixel, the pixel 21c of the third pixel, and the pixel 21d of the fourth pixel, the same operation as that of the pixel 21a described above is performed. In this case, the second data Coln2 and the third data Coln3 of the pixel 21b are stored in the first latch circuit 214a of any one of the pixel 21a, the pixel 21c, and the pixel 21c by the selection circuits 213. Furthermore, the second data Coln2 and the third data Coln3 of the pixel 21c are stored in the first latch circuit 214a of any one of the pixel 21a, the pixel 21b, and the pixel 21d by the selection circuits 213. Moreover, the second data Coln2 and the third data Coln3 of the pixel 21d are stored in the first latch circuit 214a of any one of the pixel 21a, the pixel 21b, and the pixel 21c by the selection circuits 213.

According to the present embodiment described above, the first latch circuit 214a can be shared by up to four pixels by the selection circuits 213. Thus, the storage circuit 214 of each pixel only needs to include one latch circuit. As a result, it is possible to suppress an increase in size of the storage circuit 214.

Note that the operation mode of the image-plane phase difference AF processing described above can also be applied to the multiplex AD processing described in the second embodiment and the single-frame HDR processing described in the third embodiment.

Furthermore, in the present embodiment, the number of pixels sharing the first latch circuit 214a is four at the maximum, but the number is not particularly limited. For example, if the number of input terminals of the selection circuit 213 is eight, the number of pixels sharing the first latch circuit 214a can be eight. In this case, for example, signal processing can be implemented in which the image-plane phase difference AF processing and the multiplex AD processing are combined.

### Ninth Embodiment

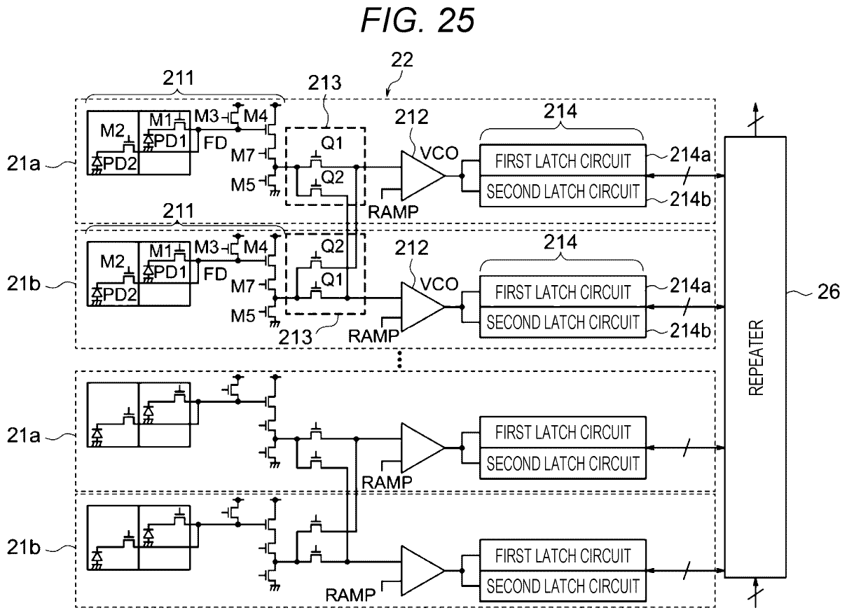

FIG. 25 is a block diagram illustrating an example of a circuit configuration of a pixel according to a ninth embodiment. In FIG. 25, the same reference signs are given to circuit elements similar to those of the pixel of the first embodiment described above, and a detailed description thereof will be omitted.

The present embodiment is different from the first embodiment in the configurations of the photoelectric conversion circuit 211 and the selection circuit 213. Specifically, the photoelectric conversion circuit 211 further includes a source follower circuit in addition to the first photodiode PD1, the second photodiode PD2, the first transfer transistor M1, the second transfer transistor M2, and the reset transistor M3. The source follower circuit includes the amplifier transistor M4, the current source transistor M5, and a selection transistor M7.

However, the source follower circuit may not be provided.

Since the amplifier transistor M4 and the current source transistor M5 have been described in the fifth embodiment (see FIG. 15), a description thereof will be omitted here. The selection transistor M7 is arranged between the amplifier transistor M4 and the current source transistor M5. The selection transistor M7 includes, for example, an N-channel MOS transistor. The drain of the selection transistor M7 is connected to the source of the amplifier transistor M4, and the source of the selection transistor M7 is connected to the drain of the current source transistor M5 and the selection circuit 213. The selection signal is input from the pixel drive circuit 23 to the gate of the selection transistor M7. On the basis of this selection signal, when the selection transistor M7 is turned on, the analog pixel signal SIG amplified by the amplifier transistor M4 is input to the selection circuit 213.

Furthermore, the present embodiment is different from the first embodiment in that the selection circuit 213 is arranged on the input terminal side of the comparator 212. The selection circuit 213 includes a first switching element Q1 and a second switching element Q2. The selection circuit 213 of the pixel 21a and the selection circuit 213 of the pixel 21b constitute the switching circuit 215. The first switching element Q1 and the second switching element Q2 each include, for example, an N-channel MOS transistor. Furthermore, the first switching element Q1 and the second switching element Q2 are turned on and off on the basis of a control signal input to each gate from the pixel drive circuit 23.

The first switching element Q1 of the pixel 21a switches whether or not to connect the photoelectric conversion circuit 211 of the pixel 21a and the first input terminal of the comparator 212 of the pixel 21a to each other on the basis of the above control signal. Meanwhile, the second switching element Q2 of the pixel 21a switches whether or not to connect the photoelectric conversion circuit 211 of the pixel 21a and the first input terminal of the comparator 212 of the pixel 21b to each other.

The first switching element Q1 of the pixel 21b switches whether or not to connect the photoelectric conversion circuit 211 of the pixel 21b and the first input terminal of the comparator 212 of the pixel 21b to each other on the basis of the above control signal. Meanwhile, the second switching element Q2 of the pixel 21b switches whether or not to connect the photoelectric conversion circuit 211 of the pixel 21b and the first input terminal of the comparator 212 of the pixel 21a to each other.

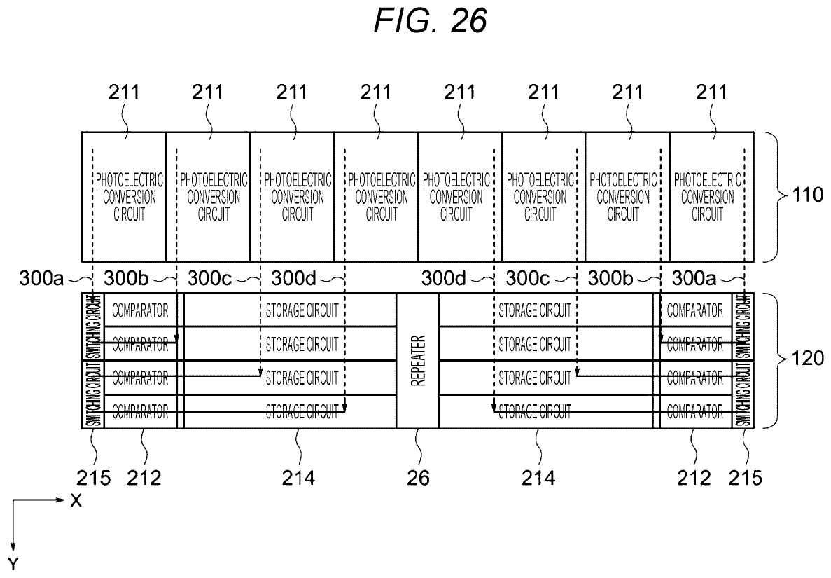

FIG. 26 is a diagram illustrating a layout example of pixels according to the ninth embodiment. Also in the present embodiment, as in the layout illustrated in FIG. 5, the repeater 26 is arranged at the position facing the center of the eight photoelectric conversion circuits 211. Furthermore, the comparators 212, the switching circuits 215, and the storage circuits 214 are arranged symmetrically with the repeater 26 interposed in the row direction X. However, in the present embodiment, the switching circuit 215 is provided on the input terminal side of the comparator 212. Thus, each circuit is arranged.

Hereinafter, a description will be given of an operation mode in which the image-plane phase difference AF processing is executed in the pixel 21a according to the present embodiment configured as described above. However, differences from the first embodiment will be mainly described here.

In the first reset period (P1-phase), the first switching element Q1 of each pixel is turned on, and the second switching element Q2 is turned off. Thus, the first data Colnla of the first output signal VCO1a output from the comparator 212 of the pixel 21a is stored in the first latch circuit 214a of the pixel 21a.

Furthermore, in the second reset period (P2-phase), the first switching element Q1 of each pixel is turned off, and the second switching element Q2 is turned on. Thus, the first data Coln1b of the first output signal VCO1b output from the comparator 212 of the pixel 21b is stored in the first latch circuit 214a of the pixel 21b.

Furthermore, in the first data acquisition period (D1-phase), as in the first reset period, the first switching element Q1 of each pixel is turned on, and the second switching element Q2 is turned off. Thus, the comparator 212 of the pixel 21a compares the analog pixel signal SIG output from the photoelectric conversion circuit 211 of the pixel 21a with the ramp signal RAMP, and outputs the second output signal VCO2a. The second data Coln2a of the second output signal VCO2a is stored in the second latch circuit 214b of the pixel 21a.

Moreover, in the second data acquisition period (D2-phase), as in the second reset period, the first switching element Q1 of each pixel is turned off, and the second switching element Q2 is turned on. Thus, the comparator 212 of the pixel 21b compares the analog pixel signal SIG output from the photoelectric conversion circuit 211 of the pixel 21a with the ramp signal RAMP, and outputs the second output signal VCO2b. The second data Coln2b of the second output signal VCO2b is stored in the second latch circuit 214b of the pixel 21b. Note that, in the second data acquisition period, since both the first transfer transistor M1 and the second transfer transistor M2 are turned on, the analog pixel signal SIG has a different level from that in the first data acquisition period.

According to the present embodiment described above, even if the selection circuit 213 is arranged on the input terminal side of the comparator 212, the storage circuit 214 can be shared between the pixel 21a and the pixel 21b when the analog pixel signal SIG is digitally converted. Thus, it is possible to suppress a decrease in signal processing speed while avoiding an increase in size of the storage circuit 214.

### Tenth Embodiment

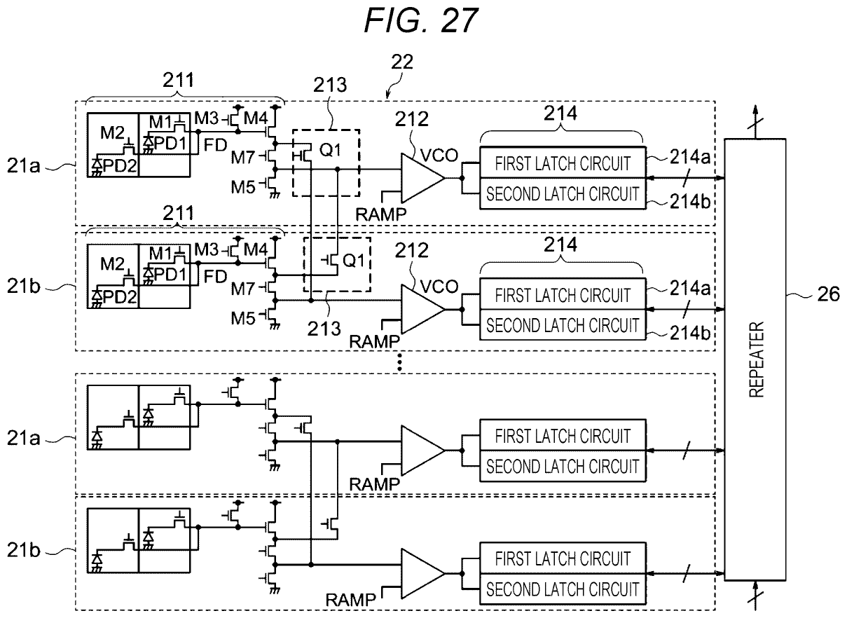

FIG. 27 is a block diagram illustrating an example of a circuit configuration of a pixel according to a tenth embodiment. In FIG. 27, the same reference signs are given to circuit elements similar to those of the pixel of the ninth embodiment described above, and a detailed description thereof will be omitted.

The present embodiment is different from the ninth embodiment in the configuration of the selection circuit 213. The selection circuit 213 is different from that of the ninth embodiment in that only the first switching element Q1 is included. The first switching element Q1 switches the output destination of the analog pixel signal SIG amplified by the amplifier transistor M4 to the comparator 212 of the pixel 21a or the comparator 212 of the pixel 21b in cooperation with the selection transistor M7. That is, in the present embodiment, the first switching element Q1 and the selection transistor M7 function as the switching circuit 215.

The drain of the first switching element Q1 of the pixel 21a is connected to a connection point of the source of the amplifier transistor M4 and the drain of the selection transistor M7. The source of the first switching element Q1 of the pixel 21a is connected to the first input terminal of the comparator 212 of the pixel 21b.

The drain of the first switching element Q1 of the pixel 21b is connected to the first input terminal of the comparator 212 of the pixel 21a. The source of the first switching element Q1 of the pixel 21b is connected to a connection point of the amplifier transistor M4 of the pixel 21b and the drain of the selection transistor M7.

Hereinafter, a description will be given of an operation mode in which the image-plane phase difference AF processing is executed in the pixel 21a according to the present embodiment configured as described above. However, differences from the ninth embodiment will be mainly described here.

In the first reset period (P1-phase), the selection transistor M7 of each pixel is turned on, and the first switching element Q1 is turned off. Thus, the first data Coln1a of the first output signal VCO1a output from the comparator 212 of the pixel 21a is stored in the first latch circuit 214a of the pixel 21a.

Furthermore, in the second reset period (P2-phase), the selection transistor M7 of each pixel is turned off, and the first switching element Q1 is turned on. Thus, the first data Coln1b of the first output signal VCO1b output from the comparator 212 of the pixel 21b is stored in the first latch circuit 214a of the pixel 21b.

Furthermore, in the first data acquisition period (D1-phase), as in the first reset period, the selection transistor M7 of each pixel is turned on, and the first switching element Q1 is turned off. Thus, the comparator 212 of the pixel 21a compares the analog pixel signal SIG amplified by the amplifier transistor M4 of the pixel 21a with the ramp signal RAMP, and outputs the second output signal VCO2a. The second data Coln2a of the second output signal VCO2a is stored in the second latch circuit 214b of the pixel 21a.

Moreover, in the second data acquisition period (D2-phase), as in the second reset period, the selection transistor M7 of each pixel is turned off, and the first switching element Q1 is turned on. Thus, the comparator 212 of the pixel 21b compares the analog pixel signal SIG amplified by the amplifier transistor M4 of the pixel 21a with the ramp signal RAMP, and outputs the second output signal VCO2b. The second data Coln2b of the second output signal VCO2b is stored in the second latch circuit 214b of the pixel 21b.

According to the present embodiment described above, the selection transistor M7 is caused to cooperate with the selection circuit 213, whereby the storage circuit 214 can be shared between the pixel 21a and the pixel 21b when the analog pixel signal SIG is digitally converted in the image-plane phase difference AF processing.

Furthermore, in the present embodiment, since the second switching element Q2 is unnecessary, the configuration of the selection circuit 213 can be simplified.

### Eleventh Embodiment

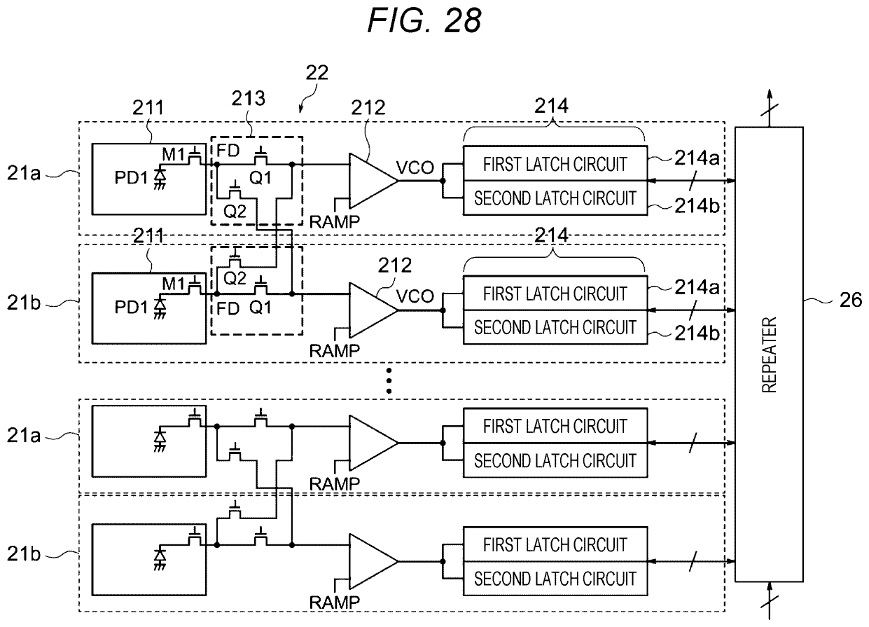

FIG. 28 is a block diagram illustrating an example of a circuit configuration of a pixel according to an eleventh embodiment. In FIG. 28, the same reference signs are given to circuit elements similar to those of the pixel of the ninth embodiment described above, and a detailed description thereof will be omitted.

The present embodiment is different from the ninth embodiment in the configuration of the photoelectric conversion circuit 211. Specifically, the photoelectric conversion circuit 211 is provided with the first photodiode PD1 and the first transfer transistor M1, but is not provided with the second photodiode PD2 or the second transfer transistor M2.

Furthermore, in the present embodiment, the amplifier transistor M4, the current source transistor M5, and the selection transistor M7 are also not provided in the photoelectric conversion circuit 211. Thus, the drain of the first switching element Q1 is connected to the floating diffusion layer FD.

Hereinafter, a description will be given of an operation mode in which the multiplex AD processing is executed in the pixel 21a according to the present embodiment configured as described above. However, differences from the second embodiment will be mainly described here.

In the first reset period (P1-phase) of the pixel 21a, the first transfer transistor M1 of the pixel 21a is turned off, and the first switching element Q1 and the second switching element Q2 are turned on in accordance with the control by the pixel drive circuit 23. At this time, in the pixel 21b, the first transfer transistor M1, the first switching element Q1, and the second switching element Q2 are turned off. As a result, the first output signal VCO1a is output from the comparator 212 of the pixel 21a. Subsequently, the first data Colnla of the first output signal VCO1a is written to the first latch circuit 214a of the pixel 21a.

Furthermore, in the present embodiment, the second reset period (P2-phase) is the same time as the first reset period (P1-phase). Thus, the first output signal VCO1b is output from the comparator 212 of the pixel 21b simultaneously with the output of the first output signal VCO1a. Subsequently, the first data Coln1b of the first output signal VCO1b is written to the first latch circuit 214a of the pixel 21b. Thereafter, when the reset transistor of the pixel 21a is turned off on the basis of the reset signal from the pixel drive circuit 23, the reset state of the floating diffusion layer FD is released.

Furthermore, in the charge transfer period (FD transfer) of the pixel 21a, the first transfer transistor M1, the first switching element Q1, and the second switching element Q2 of the pixel 21a are turned on. As a result, in the pixel 21a, the charges accumulated in the first photodiode PD1 are transferred to the floating diffusion layer FD. When the charges are accumulated in the floating diffusion layer FD, the analog pixel signal SIG is generated in the floating diffusion layer FD according to the amount of charges accumulated in the first photodiode PD1.

Furthermore, in the first data acquisition period (D1-phase), the comparator 212 of the pixel 21a outputs the second output signal VCO2a. The second data Coln2a of the second output signal VCO2a is written to the first latch circuit 214a of the pixel 21a.

Moreover, in the present embodiment, similarly to the reset period, the second data acquisition period (D2-phase) is the same time as the first data acquisition period. Thus, the comparator 12 of the pixel 21b outputs the second output signal VCO2b simultaneously with the output of the second output signal VCO2a. The second data Coln2b of the second output signal VCO2b is written to the second latch circuit 214b of the pixel 21b.

According to the present embodiment described above, even if the selection circuit 213 is arranged on the input terminal side of the comparator 212, the storage circuit 214 can be shared between the pixel 21a and the pixel 21b when the analog pixel signal SIG is digitally converted in the multiplex AD processing. As a result, it is possible to suppress a decrease in signal processing speed while avoiding an increase in size of the storage circuit 214.

Note that the pixels 21a and 21b according to the present embodiment can also be applied to the single-frame HDR processing described in the third embodiment.

### Twelfth Embodiment

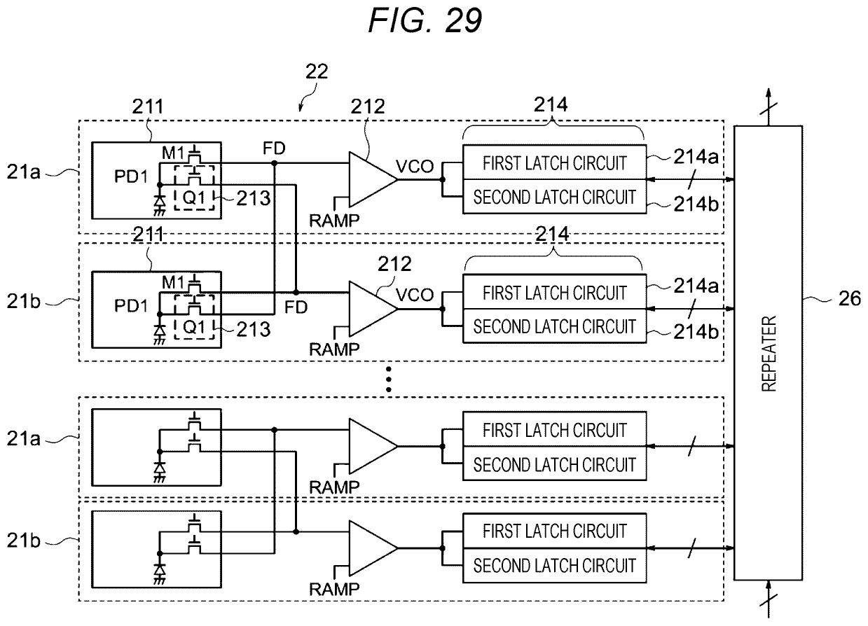

FIG. 29 is a block diagram illustrating an example of a circuit configuration of a pixel according to a twelfth embodiment. In FIG. 29, the same reference signs are given to circuit elements similar to those of the pixel of the eleventh embodiment described above, and a detailed description thereof will be omitted.

In the present embodiment, the selection circuit 213 includes only the first switching element Q1. Note that, in FIG. 29, the first switching element Q1 is arranged in the photoelectric conversion circuit 211, but may be arranged between the photoelectric conversion circuit 211 and the comparator 212.

The drain of the first switching element Q1 of the pixel 21a is connected to the anode of the first photodiode PD1 of the pixel 21a and the drain of the first transfer transistor M1. The source of the first switching element Q1 is connected to the first input terminal of the comparator 212 of the pixel 21b. Meanwhile, the drain of the first switching element Q1 of the pixel 21b is connected to the anode of the first photodiode PD1 of the pixel 21b and the drain of the first transfer transistor M1. The source of the first switching element Q1 is connected to the first input terminal of the comparator 212 of the pixel 21a.

On the basis of the control signal from the pixel drive circuit 23, when the first switching element Q1 of the pixel 21a is turned on, the charges photoelectrically converted by the first photodiode PD1 of the pixel 21a are transferred to the floating diffusion layer FD of the pixel 21b. Meanwhile, on the basis of the control signal from the pixel drive circuit 23, when the first switching element Q1 of the pixel 21b is turned on, the charges photoelectrically converted by the first photodiode PD1 of the pixel 21b are transferred to the floating diffusion layer FD of the pixel 21a.

Hereinafter, a description will be given of an operation mode in which the multiplex AD processing is executed in the pixel 21a according to the present embodiment configured as described above. However, differences from the second embodiment will be mainly described here.

In the first reset period (P1-phase) of the pixel 21a, the first transfer transistor M1 and the first switching element Q1 of the pixel 21a are turned off in accordance with the control by the pixel drive circuit 23. At this time, in the pixel 21b, the first transfer transistor M1, the first switching element Q1, and the second switching element Q2 are turned off. As a result, the first output signal VCO1a is output from the comparator 212 of the pixel 21a. Subsequently, the first data Coln1a of the first output signal VCO1a is written to the first latch circuit 214a of the pixel 21a.

Furthermore, in the present embodiment, the second reset period (P2-phase) is the same time as the first reset period (P1-phase). Thus, the first output signal VCO1b is output from the comparator 212 of the pixel 21b simultaneously with the output of the first output signal VCO1a. Subsequently, the first data Coln1b of the first output signal VCO1b is written to the first latch circuit 214a of the pixel 21b. Thereafter, when the reset transistor of the pixel 21a is turned off on the basis of the reset signal from the pixel drive circuit 23, the reset state of the floating diffusion layer FD is released.

Furthermore, in the charge transfer period (FD transfer) of the pixel 21a, the first transfer transistor M1 and the first switching element Q1 of the pixel 21a are turned on. As a result, the charges accumulated in the first photodiode PD1 of the pixel 21a are transferred to the floating diffusion layer FD of each of the pixel 21a and the pixel 21b. When the charges are accumulated in the floating diffusion layer FD, the analog pixel signal SIG is generated in the floating diffusion layer FD according to the amount of charges accumulated in the first photodiode PD1 of the pixel 21a.

Furthermore, in the first data acquisition period (D1-phase), the comparator 212 of the pixel 21a outputs the second output signal VCO2a. The second data Coln2a of the second output signal VCO2a is written to the second latch circuit 214b of the pixel 21a.

Moreover, in the present embodiment, similarly to the reset period, the second data acquisition period (D2-phase) is the same time as the first data acquisition period. Thus, the comparator 212 of the pixel 21b outputs the second output signal VCO2b simultaneously with the output of the second output signal VCO2a. The second data Coln2b of the second output signal VCO2b is written to the second latch circuit 214b of the pixel 21b.

According to the present embodiment described above, as in the eleventh embodiment, even if the selection circuit 213 is arranged on the input terminal side of the comparator 212, the storage circuit 214 can be shared between the pixel 21a and the pixel 21b when the analog pixel signal SIG is digitally converted in the multiplex AD processing. As a result, it is possible to suppress a decrease in signal processing speed while avoiding an increase in size of the storage circuit 214.

Moreover, according to the present embodiment, the second switching element Q2 is unnecessary in the selection circuit 213. Thus, the circuit configuration of the selection circuit 213 can be simplified.

Note that the pixels according to the present embodiment can also be applied to the single-frame HDR processing described in the third embodiment.

### Thirteenth Embodiment

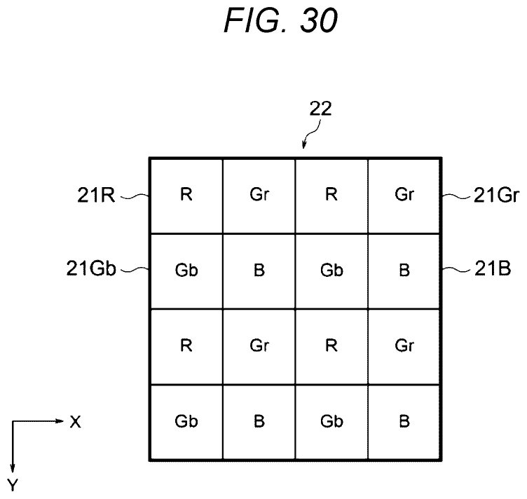

FIG. 30 is a diagram illustrating an example of a color pattern of pixels according to a thirteenth embodiment. The color pattern illustrated in FIG. 30 is a Bayer array. That is, in the pixel array unit 22, a ratio among the numbers of green pixels 21Gr and green pixels 21Gb that receive green light, the number of red pixels 21R that receive red light, and the number of blue pixels 21B that receive blue light is 2:1:1. Note that the green pixel Gr is a pixel that receives incident light transmitted through an RG color filter that transmits red light and green light. Meanwhile, the green pixel Gb is a pixel that receives incident light transmitted through a GB color filter that transmits green light and blue light.

In the present embodiment, the storage circuit 214 may be shared by pixels adjacent to each other in the row direction X or the column direction Y, that is, pixels of different colors. However, in a case where the four colors are not completed at a shutter release timing, color deviation occurs when a flash is applied. For this flash coloring countermeasure, it is desirable to share the storage circuit 214 between pixels of the same color. In this case, the pixels sharing the storage circuit 214 may be pixels of the same color arranged in the row direction X, or may be pixels of the same color arranged in the column direction Y. Furthermore, the number of pixels sharing the storage circuit 214 may be two or four.

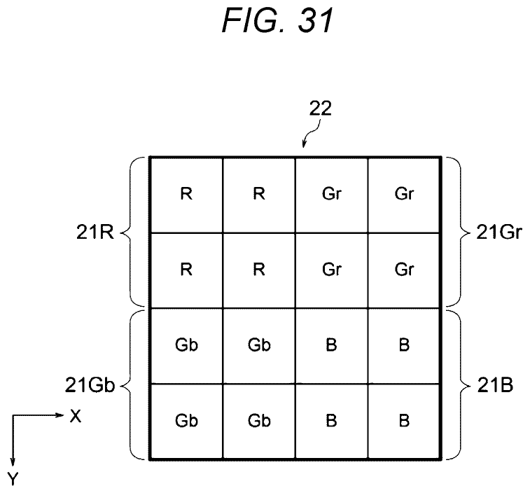

FIG. 31 is a diagram illustrating another example of the color pattern of the pixel according to the thirteenth embodiment. In the color pattern illustrated in FIG. 31, the red pixel 21R, the green pixels 21Gr and Gb, and the blue pixel 21B each are arranged in a 2×2 matrix. In this case, the number of pixels of the same color sharing the storage circuit 214 may be two or four.

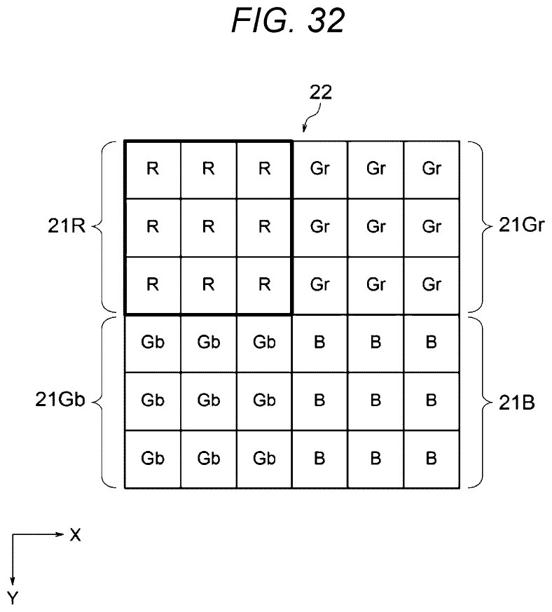

FIG. 32 is a diagram illustrating still another example of the color pattern of the pixels according to the thirteenth embodiment. In the color pattern illustrated in FIG. 32, the red pixel 21R, the green pixels 21Gr and Gb, and the blue pixel 21B each are arranged in a 3×3 matrix. In this case, the number of pixels of the same color sharing the storage circuit 214 may be three or nine.

In a case where the light detection element according to the present embodiment is applied to a mobile device such as a smartphone, for example, since the pixel pitch is narrow, there is a possibility that the comparator 212 and the storage circuit 214 having the minimum necessary functions cannot be arranged in the logic chip 120. In this case, by further increasing the number of pixels sharing the storage circuit 214, it is possible to secure an arrangement space for the circuit elements of the pixel.

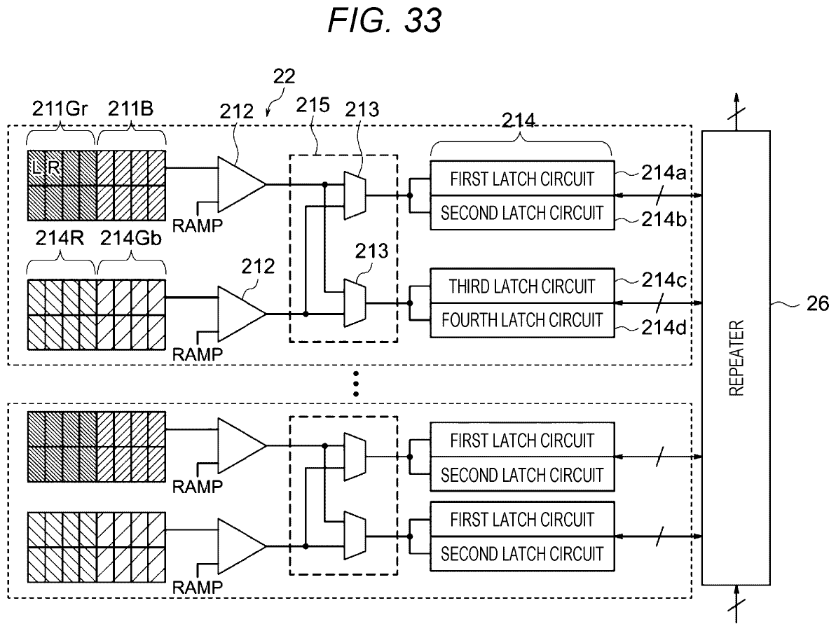

FIG. 33 is a block diagram illustrating an example of a circuit configuration of pixels arranged with the color pattern illustrated in FIG. 31. In FIG. 33, four photoelectric conversion circuits 211Gr and four photoelectric conversion circuits 211B share one comparator 212. Furthermore, four photoelectric conversion circuits 211R and four photoelectric conversion circuits 211Gb share one comparator 212. The photoelectric conversion circuit 211Gr, the photoelectric conversion circuit 211B, the photoelectric conversion circuit 211R, and the photoelectric conversion circuit 211Gb are provided in the green pixel 21Gr, the blue pixel 21B, the red pixel 21R, and the green pixel 21Gb, respectively.

Furthermore, two selection circuits 213 provided in the switching circuit 215 select one of the first latch circuit 214a to the fourth latch circuit 214d as the output destination of the output signal VCO of each comparator 212. That is, in the circuit configuration illustrated in FIG. 33, the storage circuit 214 is shared by 16 pixels.

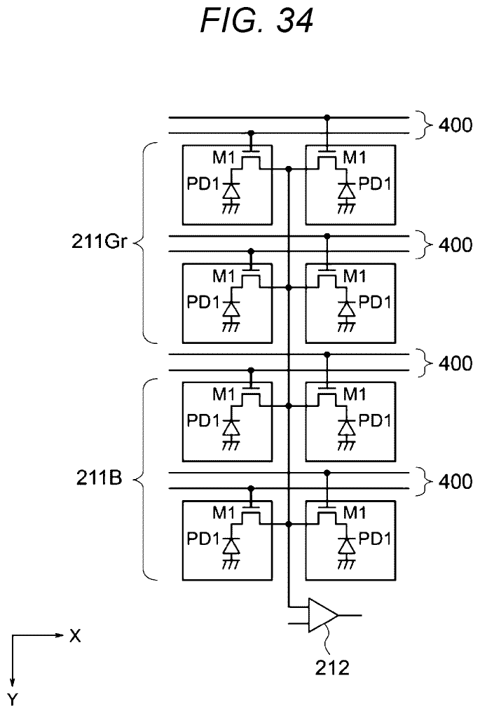

FIG. 34 is a diagram illustrating a layout example of gate wiring lines of the first transfer transistors M1 provided in each of the photoelectric conversion circuits 211Gr and 211B illustrated in FIG. 33. In FIG. 34, gate lines 400 of the first transfer transistors M1 adjacent to each other in the row direction X extend in parallel along the row direction X. In the wiring line layout illustrated in FIG. 34, the comparator 212 is shared by eight photoelectric conversion circuits 211Gr and 211B. In a case where the number of the photoelectric conversion circuits 211 shared with respect to the comparator 212 is increased, it is conceivable to extend the gate lines 400 in the row direction X or the column direction Y.

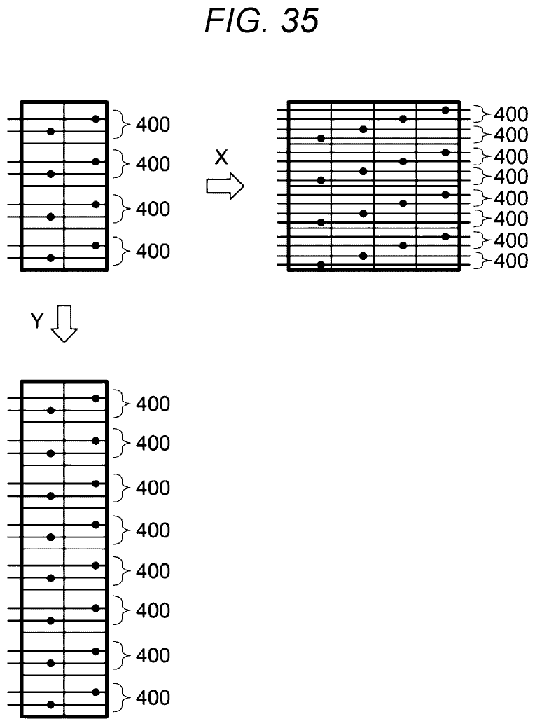

FIG. 35 is a diagram illustrating a layout example of the gate wiring lines of the first transfer transistors M1 when the number of the photoelectric conversion circuits 211 shared with respect to the comparator 212 is increased. FIG. 35 illustrates a wiring line layout in a case where the number of the photoelectric conversion circuits 211 shared with respect to the comparator 212 is increased from four to eight.

When the photoelectric conversion circuits 211 to be increased are arranged in the row direction X, the number of gate lines 400 per unit area is doubled as illustrated on the right side of FIG. 35. Thus, it is necessary to form the gate lines 400 at a high density, and moreover, an increase is caused in a processing load of the pixel drive circuit 23 that controls the first transfer transistor M1.

On the other hand, when the photoelectric conversion circuits 211 to be increased are arranged in the column direction Y, the number of gate lines 400 per unit area does not change as illustrated in the lower part of FIG. 35. Thus, wiring density does not change, and the processing load of the pixel drive circuit 23 does not increase. Thus, in a case where the number of the photoelectric conversion circuits 211 shared with respect to the comparator 212 is increased, it is desirable to arrange the photoelectric conversion circuits 211 to be increased in the column direction Y, in other words, to extend the gate line 400 in the column direction Y.

### Fourteenth Embodiment

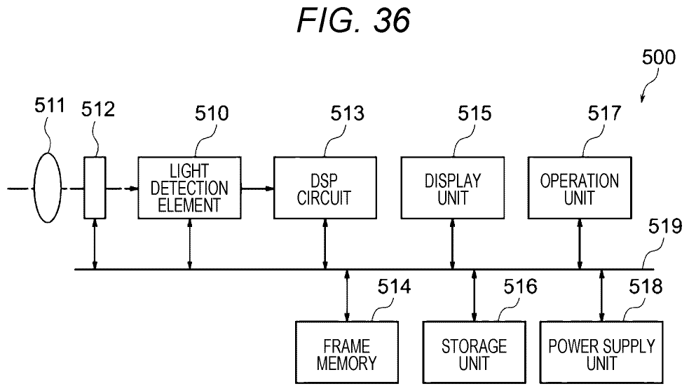

FIG. 36 is a block diagram illustrating a schematic configuration of an electronic device according to a fourteenth embodiment. An electronic device 500 illustrated in FIG. 36 is an electronic device, for example, an imaging device such as a digital still camera or a video camera, or a mobile terminal device such as a smartphone or a tablet terminal.

The electronic device 500 includes, for example, a light detection element 510, an optical system 511, a shutter device 512, a DSP circuit 513, a frame memory 514, a display unit 515, a storage unit 516, an operation unit 517, and a power supply unit 518. In the electronic device 500, the light detection element 510, the shutter device 512, the DSP circuit 513, the frame memory 514, the display unit 515, the storage unit 516, the operation unit 517, and the power supply unit 518 are connected to each other via a bus line 519.

Any one of the light detection elements described in the first to thirteenth embodiments described above can be applied to the light detection element 510. The optical system 511 includes one or a plurality of lenses, guides light (incident light) from a subject to the light detection element 510, and forms an image on a light receiving surface of the light detection element 510.

The shutter device 512 is arranged between the optical system 511 and the light detection element 510, and controls a light irradiation period and a light shielding period for the light detection element 510. The DSP circuit 513 is a signal processing circuit that processes an output signal of the light detection element 510. The frame memory 514 temporarily holds image data processed by the DSP circuit 513 in units of frames.

The display unit 515 includes, for example, a panel type display device such as a liquid crystal panel or an organic electro luminescence (EL) panel, and displays a moving image or a still image captured by the light detection element 510. The storage unit 516 records image data of a moving image or a still image captured by the light detection element 510 in a recording medium such as a semiconductor memory or a hard disk.

The operation unit 517 issues operation commands for various functions of the electronic device 500 in accordance with operation by a user. The power supply unit 518 appropriately supplies various power supplies serving as operation power supplies of the light detection element 510, the shutter device 512, the DSP circuit 513, the frame memory 514, the display unit 515, the storage unit 516, and the operation unit 517 to these supply targets.

In the electronic device 500 configured as described above, when the user gives an instruction to start imaging by operating the operation unit 517, the operation unit 517 transmits an imaging command to the light detection element 510. When receiving the imaging command, the light detection element 510 performs various settings (for example, the above-described image quality adjustment and the like). Subsequently, the light detection element 510 executes imaging by a predetermined imaging method.

The light detection element 510 outputs a signal obtained by imaging to the DSP circuit 513. The DSP circuit 513 performs predetermined signal processing (for example, noise reduction processing or the like) on the output signal of the light detection element 510. The DSP circuit 513 causes the frame memory 514 to hold the image data subjected to the predetermined signal processing, and the frame memory 514 causes the storage unit 516 to store the image data. In this manner, imaging in the electronic device 500 is performed.

According to the present embodiment described above, any one of the light detection elements according to the first to thirteenth embodiments described above can be applied to the light detection element 510. Thus, it is possible to suppress a decrease in signal processing speed while avoiding an increase in size of the storage circuit 214.

### <Application Example to Mobile Body>

The technology according to the present disclosure (the present technology) can be applied to various products. For example, the technology according to the present disclosure may be achieved in the form of a device to be mounted on a mobile body of any kind, such as an automobile, an electric vehicle, a hybrid electric vehicle, a motorcycle, a bicycle, a personal mobility, an airplane, a drone, a vessel, or a robot.

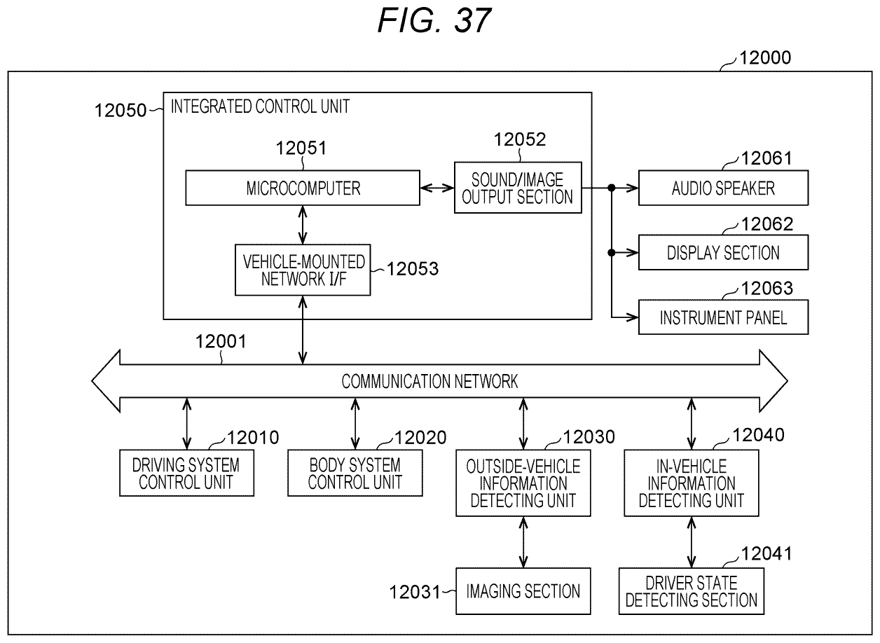

FIG. 37 is a block diagram illustrating a schematic configuration example of a vehicle control system that is an example of a mobile body control system to which the technology according to the present disclosure can be applied.

The vehicle control system 12000 includes a plurality of electronic control units connected to each other via a communication network 12001. In the example illustrated in FIG. 37, the vehicle control system 12000 includes a driving system control unit 12010, a body system control unit 12020, an outside-vehicle information detecting unit 12030, an in-vehicle information detecting unit 12040, and an integrated control unit 12050. Furthermore, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound or an image to an output device, which is capable of notifying a passenger of the vehicle or a person outside the vehicle of information visually or auditorily. In the example of FIG. 37, an audio speaker 12061, a display section 12062, and an instrument panel 12063 are illustrated as the output device. The display section 12062 may, for example, include at least one of an on-board display or a head-up display.

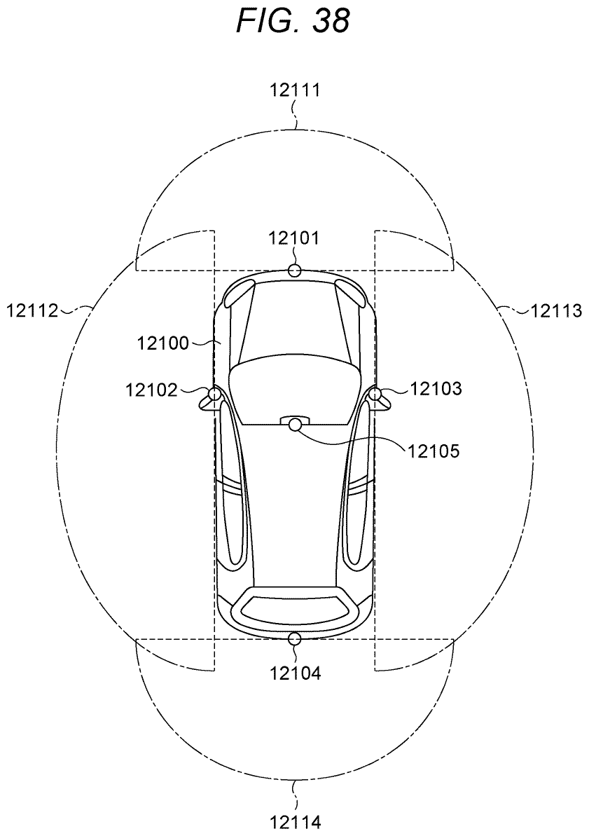

FIG. 38 is a diagram illustrating an example of installation positions of the imaging section 12031.

In FIG. 38, imaging sections 12101, 12102, 1210312104, and 12105 are included as the imaging section 12031.

The imaging sections 12101, 12102, 1210312104, and 12105 are provided, for example, at positions such as a front nose, a sideview mirror, a rear bumper, a back door, and an upper portion of a windshield within an interior of the vehicle 12100.

Each of the imaging section 12101 on the front nose and the imaging section 12105 on the upper part of the windshield in the interior mainly obtains an image of an area in front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Note that FIG. 38 illustrates an example of imaging ranges of the imaging sections 12101 to 12104. An imaging range 12111 represents the imaging range of the imaging section 12101 provided to the front nose. An imaging range 1211212113 represents the imaging range of the imaging sections 12102 and 12103 provided on the sideview mirrors. An imaging range 12114 represents the imaging range of the imaging section 12104 provided on the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera including a plurality of imaging devices, or may be an imaging device having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Moreover, the microcomputer 12051 can set a following distance to be maintained in front of a preceding vehicle in advance, and perform automatic brake control (including following block control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object.

When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

In the above, an example has been described of the vehicle control system to which the technology according to the present disclosure can be applied. The technology according to the present disclosure is applicable to, for example, imaging sections 7910, 7912, 7914, 7916, and 7918 and outside-vehicle information detecting sections 7920, 7922, 7924, 7926, 7928, and 7930 out of the components described above. Then, in particular, it is possible to suppress a decrease in signal processing speed while avoiding an increase in size of the imaging device. Thus, application of the technology according to the present disclosure can contribute to downsizing and speeding up of the vehicle control system.

Note that the present technology can have the following configurations.

(1) A light detection element including
a plurality of pixels arranged in a matrix, in which
the plurality of pixels includes:
a photoelectric conversion circuit that photoelectrically converts incident light to output an analog pixel signal;
a comparator that outputs a result of comparing the analog pixel signal with a reference signal;
a storage circuit that stores data of an output signal of the comparator; and
a switching circuit that switches an output destination of the analog pixel signal or the output signal to share the storage circuit among the plurality of pixels.

(2) The light detection element according to (1), in which the switching circuit is arranged on an output terminal side of the comparator.

(3) The light detection element according to (1), in which the switching circuit is arranged on an input terminal side of the comparator.

(4) The light detection element according to any of (1) to (3), in which
the photoelectric conversion circuit includes a first photodiode and a second photodiode connected to an input terminal of the comparator,
the comparator outputs a first output signal when the photoelectric conversion circuit is in a reset state, outputs a second output signal indicating a result of comparison between an analog pixel signal when the first photodiode photoelectrically converts the incident light and the reference signal, and outputs a third output signal indicating a result of comparison between an analog pixel signal when the first photodiode and the second photodiode photoelectrically convert the incident light and the reference signal,
the storage circuit includes a plurality of latch circuits, and
the switching circuit switches output destinations of the first output signal, the second output signal, and the third output signal to different latch circuits, respectively.

(5) The light detection element according to any of (1) to (3), in which
the photoelectric conversion circuit includes a first photodiode connected to an input terminal of the comparator,
the comparator outputs a first output signal when the photoelectric conversion circuit is in a reset state, and outputs a plurality of times a second output signal indicating a result of comparison between an analog pixel signal when the first photodiode photoelectrically converts the incident light and the reference signal,
the storage circuit includes a plurality of latch circuits, and
the switching circuit switches output destinations of the first output signal and the second output signal of each time to different latch circuits, respectively.

(6) The light detection element according to (5), in which the comparator outputs the second output signal a plurality of times by performing AD conversion processing on an analog pixel signal once transferred to a floating diffusion layer a plurality of times.

(7) The light detection element according to (5), in which the comparator outputs the second output signal under different conditions every time.

(8) The light detection element according to (5), in which the comparator outputs the second output signal under a condition that a gain of at least one of the analog pixel signal or the reference signal is changed.

(9) The light detection element according to any of (1) to (8), in which the switching circuit switches an output destination of the analog pixel signal or the output signal to cause pixels adjacent to each other to share the storage circuit, among the plurality of pixels.

(10) The light detection element according to any of (1) to (9), in which
the plurality of pixels individually receives beams of light of a plurality of colors, and
the storage circuit is shared by pixels that receive light of an identical color.

(11) The light detection element according to (4), in which
the plurality of pixels includes a first pixel and a second pixel adjacent to the first pixel,
the storage circuit includes a first latch circuit and a second latch circuit, and
the switching circuit selects, as an output destination of the first output signal, the first latch circuit of the first pixel, selects, as an output destination of the second output signal, the second latch circuit of the first pixel, and selects, as an output destination of the third output signal, the first latch circuit of the second pixel.

(12) The light detection element according to (5), in which
the plurality of pixels includes a first pixel and a second pixel adjacent to the first pixel,
the comparator outputs the second output signal twice,
the storage circuit includes a first latch circuit and a second latch circuit, and
the switching circuit selects, as an output destination of the first output signal, the first latch circuit of the first pixel, selects, as an output destination of the second output signal of a first time, the second latch circuit of the first pixel, and selects, as an output destination of the second output signal of a second time, the first latch circuit of the second pixel.

(13) The light detection element according to any of (1) to (12), in which
the plurality of pixels includes a first pixel to a fourth pixel arranged close to each other,
the storage circuit includes a first latch circuit, and
the number of pixels sharing the first latch circuit is variable among the first pixel to the fourth pixel.

(14) The light detection element according to (1), further including:
a first chip in which a plurality of photoelectric conversion circuits is arranged; and
a second chip in which a plurality of comparators, a plurality of storage circuits, a plurality of switching circuits, and a repeater that reads the data from the storage circuits are arranged, in which
the repeater is arranged at a position facing the center of the plurality of photoelectric conversion circuits, and the plurality of comparators, the plurality of storage circuits, and the plurality of switching circuits are arranged symmetrically with the repeater interposed therebetween.

(15) The light detection element according to (14), in which the storage circuits are arranged on both sides of the repeater, the comparators are arranged on one sides of the storage circuits, and the switching circuits are arranged on one sides of the comparators.

(16) The light detection element according to (2), in which the switching circuit includes a multiplexer.

(17) The light detection element according to (3), in which the switching circuit includes:
a first switching element that switches whether or not to output the analog pixel signal to a first pixel among the plurality of pixels; and
a second switching element that switches whether or not to output the analog pixel signal to a second pixel different from the first pixel.

(18) The light detection element according to (1), in which
the photoelectric conversion circuit includes a selection transistor that switches whether or not to output the analog pixel signal to a comparator of a first pixel among the plurality of pixels, and
the switching circuit includes a first switching element that switches whether or not to output the analog pixel signal to a comparator of a second pixel different from the first pixel.

(19) The light detection element according to (1), in which
the photoelectric conversion circuit includes a transfer transistor that switches whether or not to transfer a charge obtained by photoelectrically converting the incident light to a floating diffusion layer of a first pixel among the plurality of pixels, and
the switching circuit includes a first switching element that switches whether or not to transfer the charge to a floating diffusion layer of a second pixel different from the first pixel.

(20) An electronic device including
a plurality of pixels arranged in a matrix, in which
the plurality of pixels includes:
a photoelectric conversion circuit that photoelectrically converts incident light to output an analog pixel signal;
a comparator that outputs a result of comparing the analog pixel signal with a reference signal;
a storage circuit that stores data of an output signal of the comparator; and
a switching circuit that switches an output destination of the analog pixel signal or the output signal to share the storage circuit among the plurality of pixels.

### REFERENCE SIGNS LIST

1 Light detection element
21, 21a to 21d Pixel
21R Red pixel
21Gr,21Gb Green pixel
21B Blue pixel
26 Repeater
110 Sensor chip
120 Logic chip
211 Photoelectric conversion circuit
212 Comparator
214 Storage circuit
214a First latch circuit
214b Second latch circuit
215 Switching circuit
500 Electronic device
FD Floating diffusion layer
M1 First transfer transistor
M2 Second transfer transistor
M7 Selection transistor
PD1 First photodiode
PD2 Second photodiode
Q1 First switching element
Q2 Second switching element

What is claimed is:

1. A light detection element comprising
a plurality of pixels arranged in a matrix, wherein
the plurality of pixels includes:
a photoelectric conversion circuit that photoelectrically converts incident light to output an analog pixel signal;
a comparator that outputs a result of comparing the analog pixel signal with a reference signal;
a storage circuit that stores data of an output signal of the comparator; and
a switching circuit that switches an output destination of the analog pixel signal or the output signal to share the storage circuit among the plurality of pixels.

2. The light detection element according to claim 1, wherein the switching circuit is arranged on an output terminal side of the comparator.

3. The light detection element according to claim 1, wherein the switching circuit is arranged on an input terminal side of the comparator.

4. The light detection element according to claim 1, wherein
the photoelectric conversion circuit includes a first photodiode and a second photodiode connected to an input terminal of the comparator,
the comparator outputs a first output signal when the photoelectric conversion circuit is in a reset state, outputs a second output signal indicating a result of comparison between an analog pixel signal when the first photodiode photoelectrically converts the incident light and the reference signal, and outputs a third output signal indicating a result of comparison between an analog pixel signal when the first photodiode and the second photodiode photoelectrically convert the incident light and the reference signal,
the storage circuit includes a plurality of latch circuits, and
the switching circuit switches output destinations of the first output signal, the second output signal, and the third output signal to different latch circuits, respectively.

5. The light detection element according to claim 1, wherein
the photoelectric conversion circuit includes a first photodiode connected to an input terminal of the comparator,
the comparator outputs a first output signal when the photoelectric conversion circuit is in a reset state, and outputs a plurality of times a second output signal indicating a result of comparison between an analog pixel signal when the first photodiode photoelectrically converts the incident light and the reference signal,
the storage circuit includes a plurality of latch circuits, and
the switching circuit switches output destinations of the first output signal and the second output signal of each time to different latch circuits, respectively.

6. The light detection element according to claim 5, wherein the comparator outputs the second output signal a plurality of times by performing AD conversion processing on an analog pixel signal once transferred to a floating diffusion layer a plurality of times.

7. The light detection element according to claim 5, wherein the comparator outputs the second output signal under different conditions every time.

8. The light detection element according to claim 5, wherein the comparator outputs the second output signal under a condition that a gain of at least one of the analog pixel signal or the reference signal is changed.

9. The light detection element according to claim 1, wherein the switching circuit switches an output destination of the analog pixel signal or the output signal to cause pixels adjacent to each other to share the storage circuit, among the plurality of pixels.

10. The light detection element according to claim 1, wherein
the plurality of pixels individually receives beams of light of a plurality of colors, and
the storage circuit is shared by pixels that receive light of an identical color.

11. The light detection element according to claim 4, wherein
the plurality of pixels includes a first pixel and a second pixel adjacent to the first pixel,
the storage circuit includes a first latch circuit and a second latch circuit, and
the switching circuit selects, as an output destination of the first output signal, the first latch circuit of the first pixel, selects, as an output destination of the second output signal, the second latch circuit of the first pixel, and selects, as an output destination of the third output signal, the first latch circuit of the second pixel.

12. The light detection element according to claim 5, wherein
the plurality of pixels includes a first pixel and a second pixel adjacent to the first pixel,
the comparator outputs the second output signal twice,
the storage circuit includes a first latch circuit and a second latch circuit, and
the switching circuit selects, as an output destination of the first output signal, the first latch circuit of the first pixel, selects, as an output destination of the second output signal of a first time, the second latch circuit of the first pixel, and selects, as an output destination of the second output signal of a second time, the first latch circuit of the second pixel.

13. The light detection element according to claim 1, wherein
the plurality of pixels includes a first pixel to a fourth pixel arranged close to each other,
the storage circuit includes a first latch circuit, and
a number of pixels sharing the first latch circuit is variable among the first pixel to the fourth pixel.

14. The light detection element according to claim 1, further comprising:
a first chip in which a plurality of photoelectric conversion circuits is arranged; and
a second chip in which a plurality of comparators, a plurality of storage circuits, a plurality of switching circuits, and a repeater that reads the data from the storage circuits are arranged, wherein
the repeater is arranged at a position facing a center of the plurality of photoelectric conversion circuits, and the plurality of comparators, the plurality of storage circuits, and the plurality of switching circuits are arranged symmetrically with the repeater interposed therebetween.

15. The light detection element according to claim 14, wherein the storage circuits are arranged on both sides of the repeater, the comparators are arranged on one sides of the storage circuits, and the switching circuits are arranged on one sides of the comparators.

16. The light detection element according to claim 2, wherein the switching circuit includes a multiplexer.

17. The light detection element according to claim 3, wherein
the switching circuit includes:
a first switching element that switches whether or not to output the analog pixel signal to a first pixel among the plurality of pixels; and
a second switching element that switches whether or not to output the analog pixel signal to a second pixel different from the first pixel.

18. The light detection element according to claim 1, wherein
the photoelectric conversion circuit includes a selection transistor that switches whether or not to output the analog pixel signal to a comparator of a first pixel among the plurality of pixels, and
the switching circuit includes a first switching element that switches whether or not to output the analog pixel signal to a comparator of a second pixel different from the first pixel.

19. The light detection element according to claim 1, wherein
the photoelectric conversion circuit includes a transfer transistor that switches whether or not to transfer a charge obtained by photoelectrically converting the incident light to a floating diffusion layer of a first pixel among the plurality of pixels, and
the switching circuit includes a first switching element that switches whether or not to transfer the charge to a floating diffusion layer of a second pixel different from the first pixel.

20. An electronic device comprising
a plurality of pixels arranged in a matrix, wherein
the plurality of pixels includes:
a photoelectric conversion circuit that photoelectrically converts incident light to output an analog pixel signal;
a comparator that outputs a result of comparing the analog pixel signal with a reference signal;
a storage circuit that stores data of an output signal of the comparator; and
a switching circuit that switches an output destination of the analog pixel signal or the output signal to share the storage circuit among the plurality of pixels.
